(19) United States
(12) Patent Application Publication
(10) Pub. No.: US 2025/0173120 A1
(43) Pub. Date: May 29, 2025

(54) SOUND PRODUCTION APPARATUS, SOUND PRODUCTION METHOD, AND A SOUND PRODUCTION PROGRAM PRODUCT

(71) Applicant: Sony Group Corporation, Tokyo (JP)

(72) Inventors: Naoki Shinmen, Tokyo (JP); Natsuko Maeda, Kanagawa (JP); Yuta Sato, Kanagawa (JP); Atsushi Yamamoto, Tokyo (JP); Kazuki Sakai, Tokyo (JP); Koya Sato, Kanagawa (JP); Yuji Nakanishi, Tokyo (JP)

(73) Assignee: Sony Group Corporation, Tokyo (JP)

(21) Appl. No.: 18/839,910

(22) PCT Filed: Jan. 30, 2023
(86) PCT No.: PCT/JP2023/002786

§ 371 Date: Aug. 20, 2024

(30) Foreign Application Priority Data
Feb. 28, 2022 (JP) 2022-029133

(51) Int. Cl. G06F 3/16; H04S 7/00

(52) U.S. Cl. CPC G06F 3/165; H04S 7/305

(57) ABSTRACT

A sound production apparatus (100) includes an acquisition unit (131) configured to acquire space information indicating a region of a three-dimensional virtual space including a sound source object and one or more three-dimensional objects having a first characteristic as an acoustic characteristic, and coordinate information indicating a configuration of the three-dimensional object, a display control unit configured to display the three-dimensional virtual space, an input unit (133) configured to input setting of a characteristic related to late reverberation of the three-dimensional virtual space, a change unit (134) configured to change the first characteristic related to at least one of the three-dimensional objects to a second characteristic based on a characteristic related to late reverberation, and an output control unit (135) configured to output in a switchable way a first reproduction sound synthesized based on the characteristic related to late reverberation and the first characteristic and a second reproduction sound synthesized based on the characteristic related to late reverberation and the second characteristic.

### FIELD

The present disclosure relates to a sound production apparatus, a sound production method, and a sound production program product.

### BACKGROUND

As virtual space technologies such as meta-verse and games develop, realistic experience based on reality is also required for sound reproduced on the virtual space. In research for audibly recognizing a sounding body in a three-dimensional virtual space, there are many methods for simulating the sound production. Among them, a spatial sound field reproduction technique and the like using a physical simulation are devised on the basis of a physical phenomenon in a real space, and reproducibility is high in a case where sound is reproduced on a virtual space in terms of audibility.

Examples of a physical simulation method in the acoustic field include a geometric acoustic simulation that geometrically models and calculates energy propagation of sound, a wave acoustic simulation that models and calculates wave characteristics of sound, and the like. In the former, in a case where an early reflection or the like is obtained up to the low order, the load of the calculation amount is relatively light, and high-speed processing can be expected in real-time processing required in a game or the like. However, in such a method, since a wave component of sound is excluded, it is difficult to realize diffraction and portaling (acoustic effects at boundaries between spaces that take into consideration doors or the like present in virtual space) caused by the wave, and for example, a boundary is installed in a pseudo manner, and a method of expressing a sound outside the boundary by a theoretical model is used in combination with a geometric acoustic simulation. On the other hand, the latter is known to well show microscopic wave phenomena, and is particularly advantageous for simulating low-frequency sound greatly affected by diffraction phenomena and the like. However, since such a method discretizes a space and performs calculation, a calculation load is very large as compared with the geometric acoustic simulation, and it is difficult to perform acoustic calculation following a player's line of sight in a game.

In this regard, a method of reproducing a sound close to real hearing with a low calculation amount by separately calculating the early reflection sound and the high-order reflected sound (late reverberation sound) has been presented (for example, Patent Literature 1). Furthermore, a method of adjusting the ratio of the volume between the early reflection sound and the late reverberation sound according to the distance between a sound source and a user (listening point) has been proposed (for example, Patent Literature 2).

### CITATION LIST

### Patent Literature

Patent Literature 1: JP 2000-267675 A
Patent Literature 2: JP 2019-165845 A

### SUMMARY

### Technical Problem

According to the conventional technique, sound reproducibility in the virtual space can be enhanced. However, in these conventional techniques, a large work load is required, for example, since it is necessary for a content producer to set characteristics such as reflection parameters for each of the objects constituting the virtual space. In addition, in the conventional technique, since the content producer cannot directly adjust the timbre, intuition is lacking in work, and it may be difficult to generate sound desired by the creator.

Therefore, the present disclosure proposes a sound production apparatus, a sound production method, and a sound production program product capable of reproducing a realistic sound space and reducing a work load on a content producer.

### Solution to Problem

In order to solve the above problems, a sound production apparatus according to an embodiment of the present disclosure includes: an acquisition unit configured to acquire space information indicating a region of a three-dimensional virtual space including a sound source object and one or more three-dimensional objects having a first characteristic as an acoustic characteristic, and coordinate information indicating a configuration of the three-dimensional object; a display control unit configured to display the three-dimensional virtual space; an input unit configured to input setting of a characteristic related to late reverberation of the three-dimensional virtual space; a change unit configured to change the first characteristic related to at least one of the three-dimensional objects to a second characteristic based on the characteristic related to late reverberation input by the input unit; and an output control unit configured to output in a switchable way a first reproduction sound synthesized based on the characteristic related to late reverberation and the first characteristic and a second reproduction sound synthesized based on the characteristic related to late reverberation and the second characteristic, the first reproduction sound and the second reproduction sound being a reproduction sound at a listening point of a sound emitted by the sound source object.

### BRIEF DESCRIPTION OF DRAWINGS

FIG. 1 is a diagram illustrating an overview of an information processing according to a first embodiment.

FIG. 2 is a diagram for explaining an acoustic simulation in a virtual space.

FIG. 3 is a diagram schematically illustrating a state of reflection in the acoustic simulation.

FIG. 4 is a flowchart illustrating a process of sound generation processing in the acoustic simulation.

FIG. 5 is a diagram for explaining the acoustic simulation in a case where a boundary is included between a sounding point and a listening point.

FIG. 6 is a flowchart illustrating a process in a case where a part of the sound generation processing in the acoustic simulation is omitted.

FIG. 7 is a flowchart illustrating a process of sound signal generation processing according to the first embodiment.

FIG. 8 is a data table illustrating setting items of late reverberation sound according to the first embodiment.

FIG. 9 is a diagram for explaining changing processing of a sound absorption coefficient.

FIG. 10 is a diagram (1) illustrating a display example of a user interface according to the first embodiment.

FIG. 11 is a diagram (2) illustrating a display example of a user interface according to the first embodiment.

FIG. 12 is a diagram (3) illustrating a display example of a user interface according to the first embodiment.

FIG. 13 is a diagram illustrating a configuration example of a sound production apparatus according to the first embodiment.

FIG. 14 is a flowchart illustrating a process of sound signal generation processing according to a second embodiment.

FIG. 15 is a flowchart illustrating a process of sound signal generation processing according to a third embodiment.

FIG. 16 is a flowchart illustrating a process of sound signal generation processing according to a fourth embodiment.

FIG. 17 is a flowchart illustrating a process of sound signal generation processing according to a fifth embodiment.

FIG. 18 is a flowchart illustrating a process of sound signal generation processing according to a sixth embodiment.

FIG. 19 is a hardware configuration diagram illustrating an example of a computer that implements functions of the sound production apparatus.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

The present disclosure will be described according to the following order of items.
1. First Embodiment
   1-1. Overview of Information Processing According to First Embodiment
   1-2. Sound Signal Generation Processing by Acoustic Simulation
   1-3. Sound Signal Generation Processing According to First Embodiment
   1-4. Configuration of Sound Production Apparatus According to First Embodiment
   1-5. Modification According to First Embodiment
2. Second Embodiment
3. Third Embodiment
4. Fourth Embodiment
5. Fifth Embodiment
6. Sixth Embodiment
7. Other Embodiments
8. Effects of Sound Production Apparatus According to Present Disclosure
9. Hardware Configuration

### 1. First Embodiment

### (1-1. Overview of Information Processing According to First Embodiment)

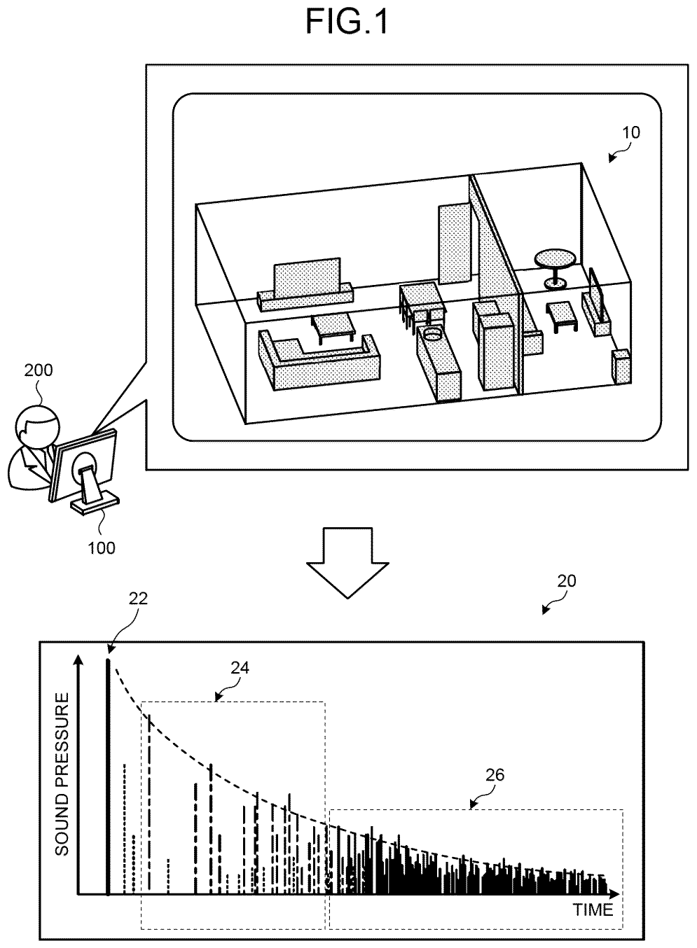

First, an overview of information processing according to a first embodiment will be described with reference to FIG. 1. FIG. 1 is a diagram illustrating an overview of the information processing according to the first embodiment.

The information processing according to the first embodiment is executed by a sound production apparatus 100 illustrated in FIG. 1. The sound production apparatus 100 is an example of the sound production apparatus according to the present disclosure, and is an information processing terminal used by a producer 200 who produces content related to a virtual space, such as a game and a metaverse. For example, the sound production apparatus 100 is a personal computer (PC), a server apparatus, a tablet terminal, or the like.

The sound production apparatus 100 includes an output unit such as a display and a speaker, and outputs various types of information to the producer 200. For example, the sound production apparatus 100 displays a user interface of software related to sound production on a display. Furthermore, the sound production apparatus 100 outputs the generated sound signal from the speaker according to the operation instructed by the producer 200 on the user interface.

In the first embodiment, the sound production apparatus 100 calculates, in a virtual three-dimensional space (hereinafter, it is simply referred to as a “virtual space”) such as a game, as what kind of sound the sound output from a sound source object that is a sounding point of the sound is reproduced at a listening point, and reproduces the calculated sound. In other words, the sound production apparatus 100 performs acoustic simulation in the virtual space, and performs processing of making a sound emitted in the virtual space close to the real world or reproducing a sound desired by the producer 200.

FIG. 1 illustrates a virtual space 10 in a game in which the producer 200 intends to design a sound. For example, the virtual space 10 is displayed on a display included in the sound production apparatus 100. The producer 200 sets the position (coordinates) of the sound source object (sounding point of the sound) in the virtual space 10, and sets the listening point (position where the user virtually listens to the sound in the virtual space 10). In a real space, a difference occurs between a sound observed near a sound source and a sound observed at a listening point due to various physical phenomena. Therefore, the sound production apparatus 100 virtually reproduces (simulates) a real physical phenomenon in the virtual space 10 according to the instruction of the producer 200, and generates a sound signal suitable for the space so as to enhance the realistic feeling of the sound expression experienced in the virtual space 10 by the game player or the like (hereinafter, referred to as the “user”) who uses the content.

Here, the sound signal generated by the sound production apparatus 100 will be described. A graph 20 schematically illustrates the intensity of the sound when the sound emitted from the sound source object is observed at the listening point. At the listening point, first, a direct sound 22 is observed, then the diffracted sound or the like of the direct sound 22 is observed, and then a primary reflection sound or the like reflected at the boundary of the virtual space is observed. The reflected sound is observed each time the sound is reflected at the boundary, and for example, reflected sounds of first to third orders are observed as an early reflection sound 24. Thereafter, a high-order reflected sound is observed as late reverberation sound 26 at the listening point. Since the sound emitted from the sound source attenuates over time, the graph 20 draws an envelope (attenuation curve) asymptotically approaching 0 with the direct sound 22 as a vertex.

The producer 200 designs the acoustic characteristics of the virtual space 10 so that the sound emitted in the virtual space 10 becomes a realistic sound with a realistic feeling for the user who listens to the sound at the listening point. Specifically, the producer 200 designs acoustic characteristics of an object arranged in the virtual space 10 and a boundary of the virtual space 10 (corresponding to a wall or a ceiling of the virtual space 10 in the example of FIG. 1).

In general, elements that affect the sound experience of reproducing the space are considered to be included in the late reverberation sound 26 rather than the early reflection sound 24. For example, the late reverberation sound 26 includes elements such as a reverberation time in the virtual space 10 and an attenuation ratio for each frequency at a listening point. That is, if the producer 200 can set the late reverberation sound 26 in the virtual space 10 as desired by the producer, the producer can control how the sound echoes in the virtual space 10.

However, as illustrated in the graph 20, since the late reverberation sound 26 is observed after the direct sound 22, the diffracted sound, and the early reflection sound 24, even if the producer 200 sets only the late reverberation sound 26, if the cooperation with the direct sound 22 and the early reflection sound 24 is not successful, an unnatural sound is reproduced as a whole. That is, the early reflection sound 24 and the late reverberation sound 26 of the virtual space 10 are required to maintain an appropriate relationship close to a real physical phenomenon.

Furthermore, in order to realize the ideal acoustic characteristics of the producer 200 in the virtual space 10, the producer 200 needs to set in advance the acoustic characteristics (sound absorption coefficient and the like) and the like of the object located in the virtual space 10 required in the acoustic simulation. Such a setting work imposes a large work load on the producer 200 and hinders the progress of the work.

Therefore, the sound production apparatus 100 according to the present disclosure inputs settings of the late reverberation sound 26 desired by the producer 200, and automatically sets the characteristics of the virtual space 10 that affect the early reflection sound 24 according to the settings. With such processing, the sound production apparatus 100 can establish the acoustic space desired by the producer 200, and can reduce the work load of the producer 200 without requiring the producer 200 to set the acoustic characteristics by himself/herself.

### (1-2. Sound Signal Generation Processing by Acoustic Simulation)

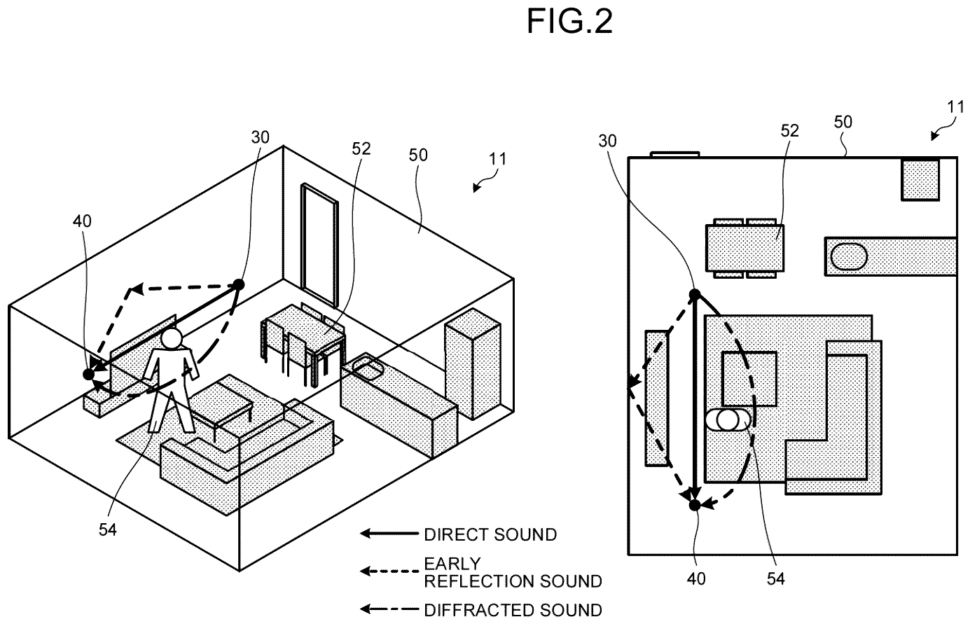

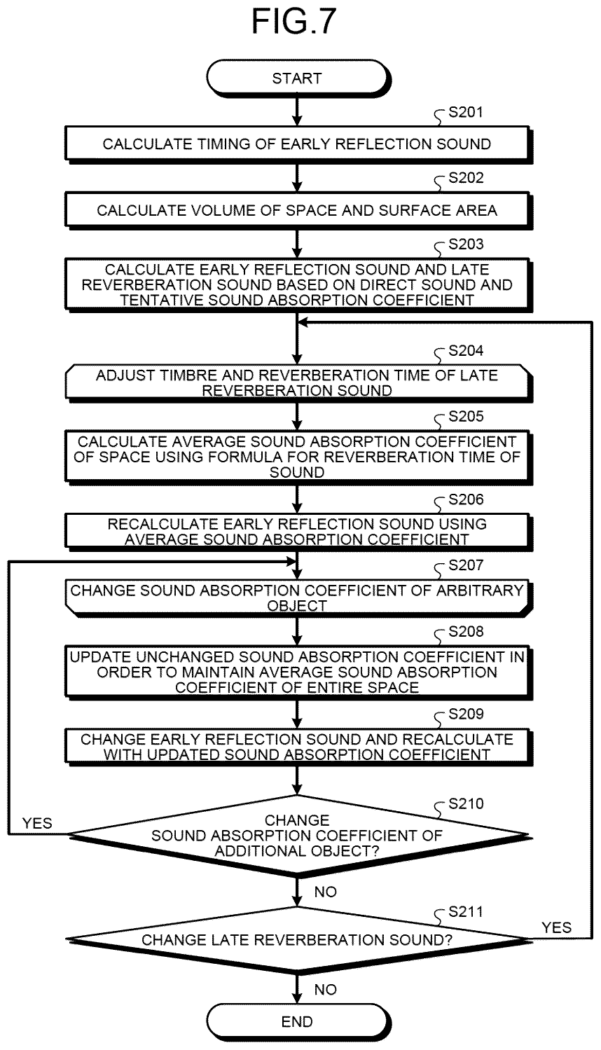

Hereinafter, information processing executed by the sound production apparatus 100 according to the present disclosure will be described in detail. First, a general generation processing method for a sound signal in a virtual space will be described with reference to FIGS. 2 to 6, and then details of acoustic processing according to the present disclosure will be described with reference to FIG. 7 and subsequent drawings.

FIG. 2 is a diagram for explaining an acoustic simulation in a virtual space. A virtual space 11 is a virtual three-dimensional space such as a game. The left diagram of FIG. 2 illustrates the virtual space 11 in a perspective view. In addition, the right diagram of FIG. 2 illustrates the virtual space 11 in plan view.

The producer 200 sets a sounding point 30, which is a position to be a sound source, and a listening point 40 on the virtual space 11. The sounding point 30 is an object that can be a so-called sound source that emits an arbitrary sound with respect to the listening point 40, and is coordinates at which the sound source object is arranged. The listening point 40 is a position where the sound output from the sounding point 30 is observed, and is, for example, a position where a game character operated by the user is located (more specifically, coordinates of a position corresponding to the head of the game character).

Furthermore, a plurality of three-dimensional objects is arranged in the virtual space 11. For example, in the virtual space 11, an object 52 that is a furniture type object and an object 54 that is a human type object are arranged. Furthermore, in the virtual space 11, a wall 50 or the like serving as a boundary forming the virtual space 11 is also arranged. Note that, since acoustic characteristics as described later are also set in the boundary such as the wall 50, in the present disclosure, the boundary such as the wall 50 is also treated as one of the virtual objects arranged in the virtual space 11.

In the example of FIG. 2, a sound is generated at the position of the sounding point 30, and at the listening point 40 assuming the head position or the like of the game character operated by the user, the sound production apparatus 100 generates a sound signal in consideration of characteristics when being propagated in the virtual space 11.

The sound production apparatus 100 acquires sound data in which sound to be produced is recorded in advance when a speech event at a sounding point is started. The sound data is, for example, sound data recorded in a library in the game. Note that the sound data is preferably data not including reverberation or the like (dry source) in consideration of being subjected to signal processing in the subsequent stage. On the other hand, a simple sound presentation in which a part of the signal processing in the subsequent stage is omitted, or a wet source in which reverberation is added for expressing a characteristic timbre may be used. Furthermore, the sound production apparatus 100 may refer to the sound data from the library and also acquire sound data generated as needed such as a synthesizer. Alternatively, the sound production apparatus 100 may acquire sound data generated as needed by simulating a sound from a structural physical simulation using a finite element method (FEM) or the like.

Furthermore, the sound production apparatus 100 acquires three-dimensional data of the virtual space 11. The three-dimensional data includes, for example, coordinates indicating a boundary shape such as a wall surface of the virtual space 11 and coordinates of an object or the like arranged inside the virtual space 11. In a case where the sounding point 30 and the listening point 40 exist in a closed space as in the example of FIG. 2, the sound production apparatus 100 acquires three-dimensional data of the entire closed space (in this example, the virtual space 11) or three-dimensional data of the entire space on the path from the sounding point 30 to the listening point 40 and the entire space continuous with the space. Note that, since the data amount increases when the three-dimensional data includes a detailed texture for video display, the sound production apparatus 100 may acquire data in which the color information, the fine shape of the surface, and the like are simplified in a form in which the acoustic parameters necessary for a physical simulation in the subsequent stage can be maintained.

Subsequently, the sound production apparatus 100 calculates a propagation path from the sounding point 30 to the listening point 40 using the acquired three-dimensional data. At this time, the direct sound path is a line-of-sight path from the sounding point 30 to the listening point 40. Note that, in a case where a transmission phenomenon such as a wall is included, even in a case where there is no line-of-sight path, a path including an obstacle is calculated. In FIG. 2, a propagation path of direct sound from the sounding point 30 to the listening point 40 is indicated by a solid line.

Furthermore, the sound production apparatus 100 calculates a path including a reflection boundary and the like until the early reflection sound (sound that reaches the listening point 40 by being reflected once on the boundary surface, and sound that reaches the listening point 40 by being reflected a small number of times, such as two or three times) reaches the listening point 40. For example, the sound production apparatus 100 obtains the propagation path of the early reflection sound using a sound ray tracing method or the like which is a geometric physical simulation method.

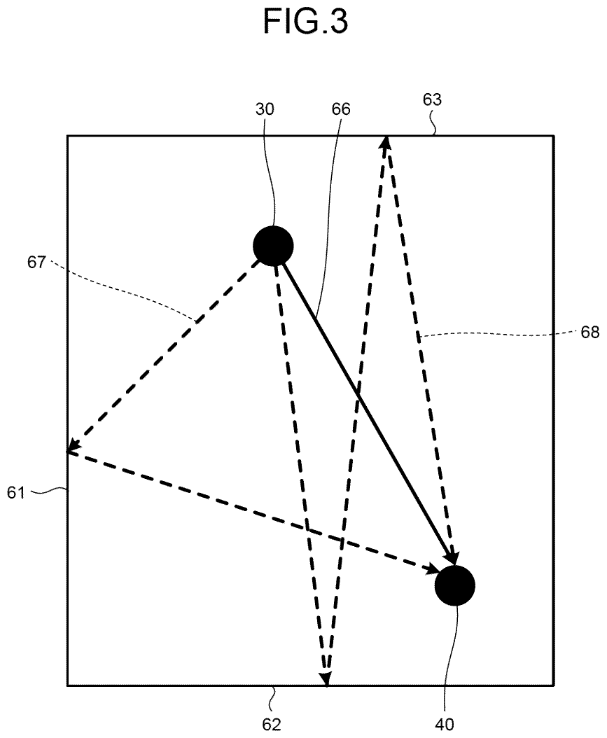

FIG. 3 illustrates an example of a propagation path calculated by the sound production apparatus 100. FIG. 3 is a diagram schematically illustrating a state of reflection in the acoustic simulation.

In the example illustrated in FIG. 3, a solid line 66 indicates a propagation path of direct sound from the sounding point 30 to the listening point 40. In addition, a dotted line 67 indicates a propagation path of the primary reflection sound that is reflected once at a boundary 61 and reaches the listening point 40. In addition, a dotted line 68 indicates a propagation path of the secondary reflection sound that is reflected twice at a boundary 62 and a boundary 63 and reaches the listening point 40.

In FIG. 3, the solid line 66, the dotted line 67, and the dotted line 68 are exemplified as propagation paths, but actual calculation includes reflection on a floor surface, a ceiling surface, and other wall surfaces, an object surface, and the like.

Returning to FIG. 2, the description will be continued. The diffracted sound reaching the listening point 40 from the sounding point 30 is obtained by bypassing the end of the obstacle located between the sounding point 30 and the listening point 40 in addition to the shortest path from the sounding point 30 to the listening point 40. In the example of FIG. 2, the object 54 is an example of an obstacle located between the sounding point 30 and the listening point 40. In this case, the sound production apparatus 100 can obtain the detour path bypassing the obstacle in an arc shape, or can obtain the detour path by a method of connecting the sounding point 30 and the end of the object 54 and the end of the object 54 and the listening point 40 with straight lines.

On the basis of the obtained information, the sound production apparatus 100 generates a sound signal to be listened at the listening point 40. First, the sound production apparatus 100 generates a sound signal based on a direct sound among the sound signals to be listened at the listening point 40. Specifically, the sound production apparatus 100 uses the acquired sound data as an input, and generates a sound signal using the spatial size and directivity of the sound source, attenuation according to the distance from the sound source to the listening point, and a deviation of the observation time due to the propagation time as parameters. For example, in a case where the sounding point 30, which is a sound source, is a non-directional point sound source, and the distance between the sounding point 30 and the listening point 40 is x, the attenuation amount is obtained as 20 log₁₀ x. The propagation time is obtained by dividing the distance x by the sound speed c. Note that, in a case where the producer 200 desires expression emphasizing a sense of distance between the sounding point 30 and the listening point 40, the sound production apparatus 100 can change the attenuation amount without being bound by a physical phenomenon in the real space.

Subsequently, the sound production apparatus 100 generates a sound signal based on an early reflection sound among the sound signals to be listened at the listening point 40. Specifically, the sound production apparatus 100 uses the acquired sound data as an input, and calculates attenuation and a time shift corresponding to the propagation path length in the medium to the propagation path source calculated in advance, similarly to the case of the direct sound. Furthermore, the sound production apparatus 100 provides predetermined attenuation for each frequency according to the sound absorption coefficient of the boundary surface reflected by the input signal.

For example, in the reflected sound corresponding to the dotted line 67 illustrated in FIG. 3, the section from the sounding point 30 to the boundary 61 and the section from the boundary 61 to the listening point 40 can be regarded as the propagation path of the medium. The sound production apparatus 100 obtains the attenuation and the time shift from the respective distances of the propagation paths. Note that the sound production apparatus 100 can calculate attenuation by holding sound absorption coefficient data and the like for each frequency in a library in advance for the boundary 61 and reading the data as needed. The sound production apparatus 100 generates the sound signal of the reflected sound corresponding to the dotted line 67 by giving attenuation according to the sound absorption coefficient to the input signal together with attenuation on the preceding propagation path. At this time, in a case where the influence of plate vibration or resonance at the boundary 61 and a nonlinear phenomenon are not considered, the sound production apparatus 100 may calculate attenuation or the like by adding the section from the sounding point 30 to the boundary 61 and the propagation path from the boundary 61 to the listening point 40.

Similarly, the sound production apparatus 100 performs calculation for the reflected sound corresponding to the dotted line 68 illustrated in FIG. 3. That is, the sound production apparatus 100 performs calculation according to the propagation path from the sounding point 30 to the boundary 62, from the boundary 62 to the boundary 63, and from the boundary 63 to the listening point 40. When calculating sounds reflected at a plurality of boundary surfaces such as the boundary 62 and the boundary 63, the sound production apparatus 100 may collectively calculate attenuation according to a sound absorption coefficient in a case where non-linear behavior according to sound pressure or the like at the boundary surface is not considered. For example, a digital filter such as an infinite impulse response (IIR) or a finite impulse response (FIR) may be used to calculate attenuation for each frequency according to the sound absorption coefficient. Note that, in the process of generating the early reflection sound, the sound production apparatus 100 may appropriately simulate the state of reflection on each wall surface using a method such as ray tracing.

Subsequently, the sound production apparatus 100 generates a sound signal related to the diffracted sound. Similarly to the early reflection sound, the sound production apparatus 100 generates a sound signal related to the diffracted sound by using a geometric method of calculating attenuation and time shift on the basis of a propagation path. It is known that the attenuation amount of the diffracted sound increases as the frequency increases in the sound diffraction phenomenon. Therefore, the sound production apparatus 100 may generate the diffracted sound by applying filters having different attenuation amounts according to frequencies. Note that, if a more accurate method based on the physical principle of the wave phenomenon is adopted, the sound production apparatus 100 can use not only the above-described geometric simulation method but also a wave acoustic simulation method from the sounding point 30 to the listening point 40. In this case, since there is a possibility that the calculation amount increases as compared with the geometric simulation, the producer 200 may use a device having sufficient calculation capability as the sound production apparatus 100 or prepare a library in which characteristics of a representative propagation path shape are calculated in advance.

Subsequently, the sound production apparatus 100 generates late reverberation sound. The late reverberation sound refers to a portion excluding the early reflection sound among sounds that are emitted from the sounding point 30 as a sound source and reach the listening point 40 by repeating reflection and diffraction in the space. This reflection or diffraction continues until the sound is completely attenuated (for example, a state in which the quantization error on the computer can be regarded as 0 (alternatively, the reproduction sound including the late reverberation sound generated on the sound production apparatus 100 may be determined as a discrimination limit in the perception of the listener by the listener operating the user interface of the sound production apparatus 100.)). In simulation, it is also possible to perform calculation until the sound is completely attenuated, but since the amount of calculation increases for each number of reflections, in practice, it is common to calculate an early reflection sound by regarding up to a plurality of reflections as an early reflection, and then calculate and synthesize the early reflection sound by another method. As a method of calculating the late reverberation sound, a method of calculating the reverberation time by a statistical method from the size of the space, the boundary surface in the space, the sound absorption coefficient on the object surface, and the like is also known in the field of architectural acoustics.

In the example of FIG. 2, the sound production apparatus 100 can use a method of using a comb filter in which acquired sound data is input, feedback is performed by multiplying the input by a predetermined gain, and the input signal is repeated at a constant cycle while being attenuated, a method of convolving data of an impulse response held in a library or the like with respect to the input signal, or the like. Note that the sound production apparatus 100 may generate late reverberation sound using other known techniques. As described above, the late reverberation sound has a great influence on the audibly space perception of the user, and thus has important significance in content production. In many existing modularized reverberation generators, it is possible to adjust a late reverberation level, a late reverberation delay time, an attenuation time, a ratio of attenuation amounts for each frequency, an echo density, a modal density, and the like as late reverberation sound settings (parameters).

The sound production apparatus 100 generates each of direct sound, early reflection sound, diffracted sound, and late reverberation sound, and then synthesizes these signals. Then, the sound production apparatus 100 outputs the synthesized sound signal to a speaker or the like as the sound observed at the listening point 40.

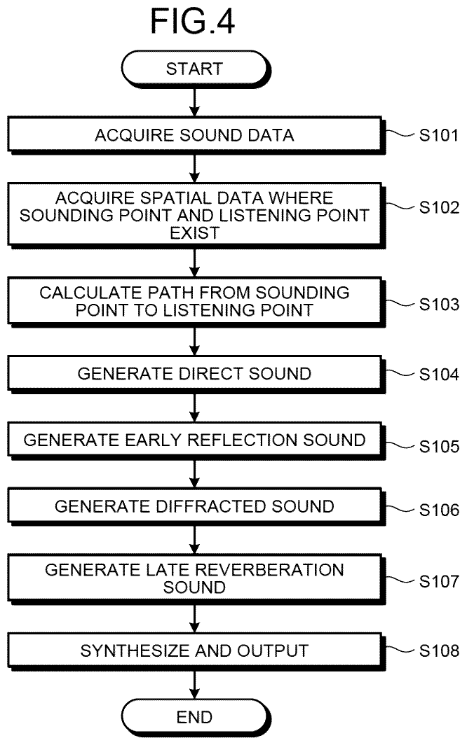

A process of the above sound signal generation processing will be described with reference to FIG. 4. FIG. 4 is a flowchart illustrating the process of sound generation processing in the acoustic simulation.

First, the sound production apparatus 100 acquires sound data of a sound emitted from the sounding point 30 (Step S101). Furthermore, the sound production apparatus 100 acquires spatial data of a space where the sounding point 30 and the listening point 40 exist (Step S102).

Subsequently, the sound production apparatus 100 calculates a path from the sounding point 30 to the listening point 40 (Step S103). Then, the sound production apparatus 100 performs each generation processing such as direct sound generation (Step S104), early reflection sound generation (Step S105), diffracted sound generation (Step S106), and late reverberation sound generation (Step S107). Finally, the sound production apparatus 100 synthesizes the respective sound signals and outputs the synthesized sound signal (Step S108).

Note that the generation processing according to Steps S104 to S106 described above does not depend on the order between the respective steps, and thus may be interchanged. Furthermore, when considering a case where diffraction occurs after reflection in a propagation path, a signal generated by calculating reflection attenuation at a boundary from a sounding point in advance may be used as an input in calculation of a diffracted sound.

Note that, although not taken into consideration in the example of FIG. 2, the sound production apparatus 100 may add processing using a transmission simulation of a sound on a boundary surface or processing using a portaling simulation technique that simulates characteristics when a small sound passes through a space such as a window or a door of a building. As a result, the sound production apparatus 100 can realize sound expression closer to the phenomenon of the real space.

Furthermore, in a case where there is a plurality of sounding points 30, the sound production apparatus 100 may process the entire processing described above in parallel for the sounds output from the plurality of sounding points 30. Alternatively, the sound production apparatus 100 may delay the time until the output until the entire processing is completed and sequentially process the sounds, and further synthesize and output the synthesis signals in which the time series of the arrival sounds at the listening point 40 are aligned.

The overview of the general-purpose sound signal generation processing has been described above with reference to FIGS. 2 to 4. Next, an example of a case where the calculation load of the sound signal generation processing can be suppressed will be described.

For example, unlike the example illustrated in FIG. 2, it is assumed that neither the sounding point 30 nor the listening point 40 exists in the closed space. In this case, the sound production apparatus 100 can branch the processing on the condition that the sounding point 30 and the listening point 40 do not exist in the closed space. This is a state in which it is assumed that both the sounding point 30 and the listening point 40 are outdoors, and since an environment with less reverberation is assumed under such a situation, the sound production apparatus 100 can omit the generation processing of the late reverberation sound.

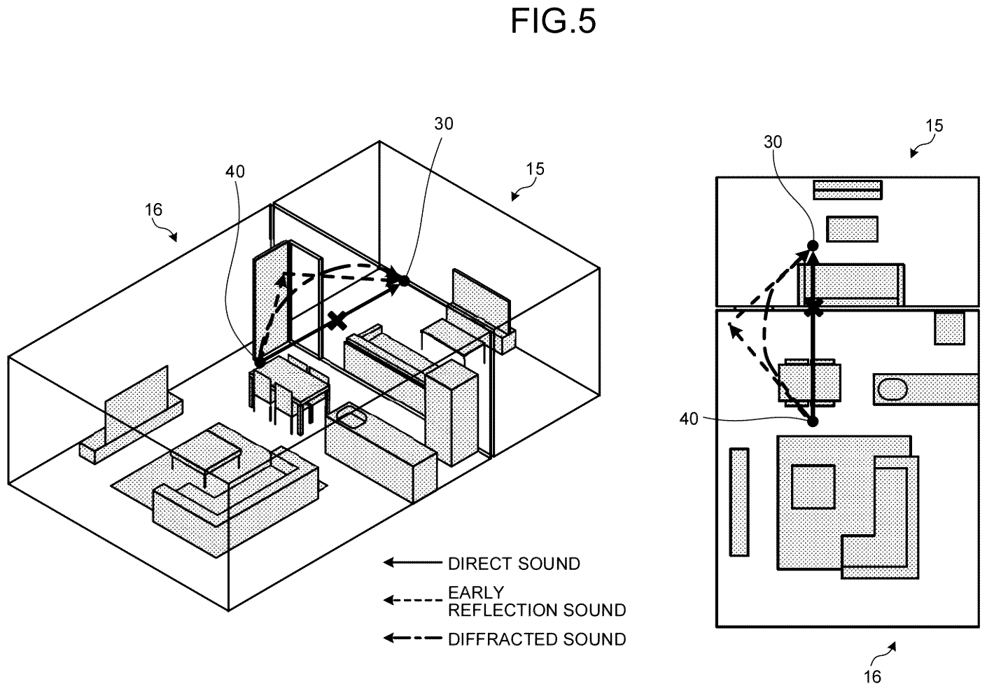

Alternatively, in a case where a boundary or a wall exists between the sounding point 30 and the listening point 40, it can be assumed that there is no direct sound, and thus, the sound production apparatus 100 can omit the processing related to the direct sound generation in the generation processing. This example will be described with reference to FIG. 5. FIG. 5 is a diagram for explaining the acoustic simulation in a case where a boundary is included between the sounding point 30 and the listening point 40. FIG. 5 exemplifies acoustic simulations in a virtual space 15 and a virtual space 16 such that a boundary (wall) exists between the sounding point 30 and the listening point 40.

In the example illustrated in FIG. 5, since the wall exists between the sounding point 30 and the listening point 40, the direct sound from the sounding point 30 to the listening point 40 is shielded. In this case, the sound production apparatus 100 can omit the direct sound generation processing. As described above, the sound production apparatus 100 can suppress the calculation load by omitting a part of the signal generation processing according to the situation of the virtual space.

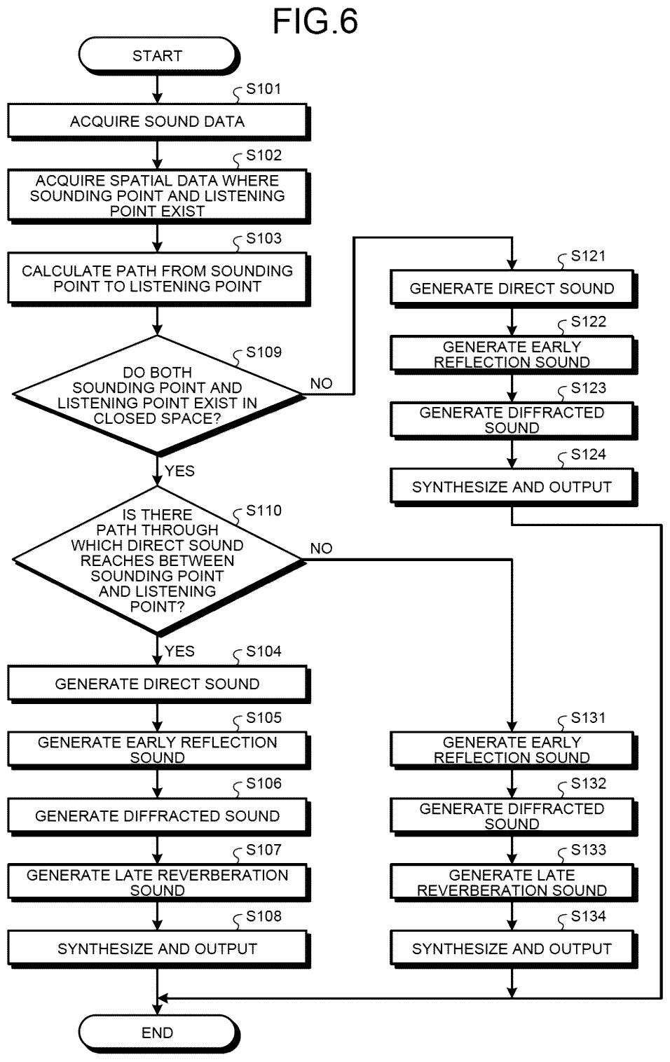

FIG. 6 is a flowchart illustrating a process in a case where a part of the sound generation processing in the acoustic simulation is omitted. For example, on the condition that the sounding point 30 and the listening point 40 do not exist in a closed space in a certain virtual space, the sound production apparatus 100 can omit a part of the processing illustrated in FIG. 4. Alternatively, the sound production apparatus 100 can omit a part of the processing illustrated in FIG. 4 on condition that there is no path through which the direct sound reaches between the sounding point 30 and the listening point 40.

Compared with the flowchart illustrated in FIG. 4, Steps S109 and S110 are newly added to the flowchart illustrated in FIG. 6. That is, the sound production apparatus 100 determines, before the sound generation processing, whether or not both the sounding point 30 and the listening point 40 exist in the closed space (Step S109).

When both the sounding point 30 and the listening point 40 do not exist in the closed space (Step S109; No), the sound production apparatus 100 performs the direct sound generation (Step S121), the early reflection sound generation (Step S122), and the diffracted sound generation (Step S123), omits the late reverberation sound generation, and outputs a synthesized sound (Step S124).

In a case where either the sounding point 30 or the listening point 40 exists in the closed space in Step S109 (Step S109; Yes), the sound production apparatus 100 further determines whether or not there is a path through which the direct sound reaches between the sounding point 30 and the listening point 40 (Step S110).

In a case where there is no path through which the direct sound reaches between the sounding point 30 and the listening point 40 (Step S110; No), the sound production apparatus 100 omits direct sound generation, performs early reflection sound generation (Step S131), diffracted sound generation (Step S132), and late reverberation sound generation (Step S133), and outputs a synthesized sound (Step S134).

On the other hand, in a case where there is a path through which the direct sound reaches between the sounding point 30 and the listening point 40 (Step S110; Yes), similarly to FIG. 2, the sound production apparatus 100 generates each of direct sound, early reflection sound, diffracted sound, and late reverberation sound, and outputs a synthesized sound signal.

### (1-3. Sound Signal Generation Processing According to First Embodiment)

The general-purpose sound signal generation processing has been described above with reference to FIGS. 2 to 6. Next, an example in a case where the sound production apparatus 100 performs the sound signal generation processing according to the first embodiment will be described.

In the real space, as described above, both the early reflection sound and the late reverberation sound are affected by the sound absorption coefficient of the boundary in the space, and have a very strong correlation. That is, in the real space, the relationship between the early reflection sound and the late reverberation sound according to the physical law is maintained. On the other hand, when considering the sound on the virtual space, as described above, the late reverberation sound is generated by signal processing different from the early reflection, and in that case, a space having a certain parameter and the relationship between the early reflection sound and the late reverberation sound according to and the physical law of the object are not necessarily maintained. For spatial representation or presentation, a content producer may adjust the late reverberation part, but at that time, parameters affected by the early reflection sounds are not adjusted, and a relationship between the early reflection sounds and the late reverberation sounds that do not follow the physical law may be made. Such a relationship that does not follow the physical law has no problem as long as the relationship is intended as presentation of expression, but if the relationship is an unintended relationship that has occurred due to insufficient adjustment of the parameter change of the early reflection sound, there is a possibility that the relationship adversely affects the user's auditory spatial perception. However, the difficulty level is different for the content producer between the adjustment of the late reverberation sound, which is the direct adjustment of the timbre, and the adjustment of the early reflection sound in which the tone is indirectly adjusted from the characteristics of the space and the boundary surface of the surface of the object, and adjusting and inputting parameters that are physically consistent for all the boundaries is an extremely high-load work.

Therefore, in the sound signal generation processing according to the first embodiment, when the producer 200 inputs desired setting of late reverberation sound, the sound production apparatus 100 changes the acoustic characteristics of the virtual space in accordance with the input late reverberation sound. Then, the sound production apparatus 100 generates an early reflection sound again using the changed acoustic characteristics, and synthesizes the generated sound as an output sound. Since the early reflection sound depends on the acoustic characteristics of the virtual space, by appropriately changing the acoustic characteristics after the late reverberation sound is set, the sound production apparatus 100 can generate the early reflection sound according to the late reverberation sound desired by the producer 200. As a result, the sound production apparatus 100 can synthesize a sound signal without discomfort in which the relationship between the early reflection sound and the late reverberation sound is maintained.

A process of sound signal generation processing according to the first embodiment will be described with reference to FIG. 7. FIG. 7 is a flowchart illustrating a process of sound signal generation processing according to the first embodiment.

First, when the producer 200 starts sound adjustment in a certain space, the sound production apparatus 100 sets the sounding point 30 and the listening point 40 at arbitrary positions in the space, and calculates the path and timing of the early reflection sound (Step S201), similarly to Steps S102 and S103 in FIG. 4. At this time, the sound production apparatus 100 may also calculate the path timing of the diffracted sound so that the producer 200 can view and confirm the sound of the entire path from the sounding point 30 to the listening point 40 in the subsequent processing.

Subsequently, the sound production apparatus 100 acquires spatial data, and calculates a volume of the space and a surface area serving as a boundary from the coordinate information (Step S202). The sound production apparatus 100 can obtain the volume of the medium (air) by, for example, calculating the volume of the entire space and the volume of the object arranged inside and subtracting the latter from the former.

Subsequently, the sound production apparatus 100 generates a direct sound, an early reflection sound, and a late reverberation sound by using a tentative sound absorption coefficient that is a parameter temporarily set for the boundary and the object (Step S203). The direct sound is generated in the same manner as in Step S104 in FIG. 4. In addition, the early reflection sound is performed by the same method as Step S105 in FIG. 4 using the tentative sound absorption coefficient as a parameter. Note that the tentative sound absorption coefficient may be an arbitrary numerical value, or may be a value read from data stored in a library associated with metadata (for example, a living room) set in advance in an assumed space, a size of the space, a boundary of the space, and a texture (material or the like) of an object arranged inside the space. In addition, the tentative sound absorption coefficient may hold a learning result of machine learning in which information of the space and the sound absorption coefficient are combined, and may be sequentially output with the space information as an input. Note that, in a case where there is a portion in contact with another object in the boundary in the space, it is also possible to omit setting of the sound absorption coefficient for the contact surface.

Note that the sound production apparatus 100 also generates the late reverberation sound once at this stage before the producer 200 inputs the settings. The sound production apparatus 100 obtains the tentative sound absorption coefficient of each boundary, and the average sound absorption coefficient of all boundaries in the space from the surface area of the boundary, and obtains the reverberation time together with the volume of air. Specifically, the sound production apparatus 100 uses the three-dimensional shape (three-dimensional data) of the space as an input, and calculates an area in contact with another boundary surface among the volume of the space, the volume of the object in the space, the area of the boundary surface (wall surface, top surface, bottom surface, etc.) of the space, the surface area of the object, and the object surface area. Then, the sound production apparatus 100 substitutes each calculated value into a predetermined formula to calculate characteristics (reverberation time and the like) related to late reverberation sound. For the calculation of the reverberation time, for example, the following Formula (1) known as Sabine's formula for reverberation in the field of architectural acoustics is used.

$$T = \frac{0.161 V}{\overline{a} S} \qquad ( 1 )$$

In the above Formula (1), the reverberation time is T, the volume of the space is V, the average sound absorption coefficient in the space is a-bar (a: average), and the total surface area of the surface not in contact with another boundary of the space is S. The above Formula (1) is used in a space where the sound absorption coefficient is relatively small and the reverberation time is long. Note that, when the average sound absorption coefficient in the space is relatively large, the following Formula (2) known as a formula of Eyring may be used.

$$T = \frac{0.161 V}{- S log ( 1 - \overline{a} )} \qquad ( 2 )$$

In addition, in a case where sound absorption by air cannot be ignored due to a relatively large space or the like, the following Formula (3) known as a Knudsen Formula including an attenuation coefficient m per unit length in addition to the above-described variables may be used.

$$T = \frac{0.161 V}{- S log ( 1 - \overline{a} )} + 4 mV \qquad ( 3 )$$

The sound production apparatus 100 obtains the reverberation time using any of the above formulas. Furthermore, the sound production apparatus 100 applies the reverberation time and tentative parameters prepared in advance to generate late reverberation sound. After Step S203, the sound production apparatus 100 synthesizes the respective sound signals and stands by in a state where the producer 200 can view the sound.

The sound production apparatus 100 completes the processing from Step S201 to Step S203 as preprocessing, and then waits for an operation by the producer 200. For example, the sound production apparatus 100 provides the producer 200 with a user interface displaying the virtual space, and waits until the producer 200 inputs an operation on the user interface. Note that, in a case where the producer 200 desires to view the tentative sound generated in Step S203 before the setting of the late reverberation sound is input, the sound production apparatus 100 may output the sound generated in Step S203.

In a case where the producer 200 inputs the setting of the late reverberation sound, the sound production apparatus 100 adjusts the timbre and the reverberation time of the late reverberation sound according to the content of the input setting (Step S204). For example, the producer 200 sets the late reverberation sound by listening to the sound synthesized in Step S203 and inputting parameters of the late reverberation sound desired by the producer 200 itself via the user interface. In other words, the producer 200 adjusts various parameters including the reverberation time of the late reverberation sound while actually confirming with audibility.

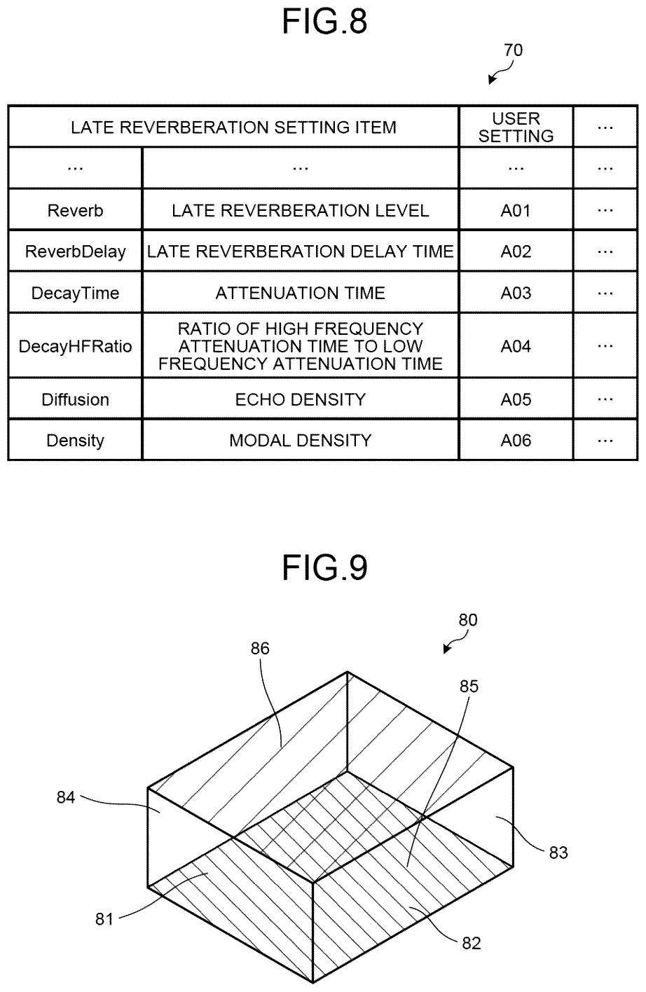

Here, FIG. 8 illustrates an example of parameters of late reverberation sound. FIG. 8 is a data table illustrating setting items of late reverberation sound according to the first embodiment. As illustrated in FIG. 8, the producer 200 may input a late reverberation level, a late reverberation delay time, an attenuation time, a ratio of a high frequency attenuation time to a low frequency attenuation time, an echo density, a modal density, and the like illustrated in a data table 70. Note that the producer 200 may set the parameters of late reverberation by an operation such as selecting a desired reverberation preset from a library stored in the sound production apparatus 100 in advance. Furthermore, user settings A01 to A06 illustrated in the data table 70 conceptually indicate parameters of late reverberation sound arbitrarily set by the producer 200.

Returning to FIG. 7, the description will be continued. The sound production apparatus 100 generates a sound reflecting the parameters of the late reverberation sound adjusted by the producer 200, and obtains the average sound absorption coefficient of the space from the sound analysis result (Step S205). As the average sound absorption coefficient, for example, one obtained by modifying any one of Formulas (1) to (3) shown in Step S203 is used. For example, in a case of a space having a small sound absorption coefficient and a long reverberation time, the sound production apparatus 100 obtains the average sound absorption coefficient on the basis of the late reverberation sound adjusted by the producer 200 using the following Formula (4) obtained by modifying Formula (1).

$${\overline{a}}^{′} = \frac{0.161 V}{TS} \qquad ( 4 )$$

Subsequently, the sound production apparatus 100 uniformly applies the average sound absorption coefficient indicated by the left side of Formula (4) to the boundaries and the objects in the virtual space. Then, the sound production apparatus 100 recalculates the early reflection sound using the boundaries or the objects in which the average sound absorption coefficient is set (Step S206).

The early reflection sound newly calculated in Step S206 conforms to a model indicating the relationship between the early reflection sound and the late reverberation sound such as the above-described Sabine's formula. That is, the newly calculated early reflection sound is consistent with the late reverberation sound.

Then, the sound production apparatus 100 may change the sound absorption coefficient of an arbitrary object according to the input of the producer 200 (Step S207). For example, when the producer 200 confirms the sound generated in Step S206 with audibility, since all boundaries and objects are uniformly set at the average sound absorption coefficient, the producer 200 may feel uncomfortable with the early reflection sound or the like. For example, in a case where a space to which the average sound absorption coefficient is uniformly attached is the virtual space 11 illustrated in FIG. 2, a space having a relatively small sound absorption coefficient such as a wall, a ceiling, a desk, or a sink is close to the average sound absorption coefficient, but a space having a large sound absorption coefficient in general such as a portion where a carpet is laid on a floor or a sofa has a difference from the average sound absorption coefficient.

The sound production apparatus 100 may set individual sound absorption coefficient for such some objects. For example, the sound production apparatus 100 may set a sound absorption coefficient set as a reference value in advance on a carpet, a sofa, or the like. Furthermore, as will be described later, the sound production apparatus 100 may perform predetermined weighting for each object and set the sound absorption coefficient for the object or the boundary. Note that, in a case where a uniform material is set at the boundaries in the space, or in a case where it is assumed that the difference in sound absorption coefficients is small in the space, the sound production apparatus 100 may omit the processing of Step S207. Note that the sound production apparatus 100 may store, in a storage unit 120, identification information of an object whose sound absorption coefficient has been changed in accordance with the input of the producer 200. In this way, the object stored in the storage unit 120 can be excluded from the process of updating the sound absorption coefficient in Step S208.

When the sound absorption coefficients of some objects are changed in Step S207, the average sound absorption coefficient in the space changes from the value obtained in Step S205. Therefore, in order to maintain the average sound absorption coefficient of the entire space obtained in Step S205, the sound production apparatus 100 updates the sound absorption coefficient of the unchanged object (Step S208).

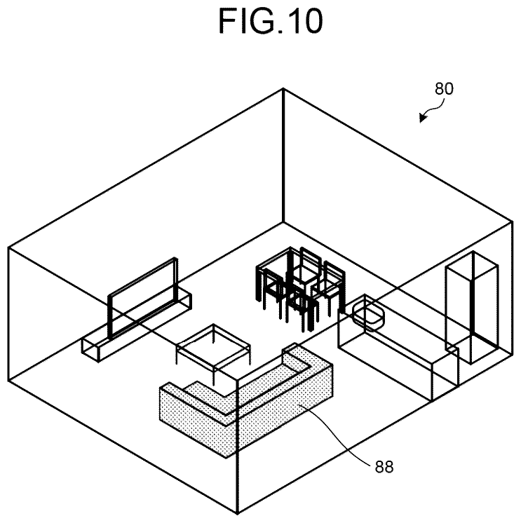

The processing in Step S208 will be described with reference to FIG. 9. FIG. 9 is a diagram for explaining changing processing of a sound absorption coefficient. FIG. 9 illustrates a virtual space 80 including six surfaces of a wall surface 81, a wall surface 82, a wall surface 83, a wall surface 84, a floor surface 85, and a ceiling 86.

The sound absorption coefficients of the wall surface 81, the wall surface 82, the wall surface 83, the wall surface 84, the floor surface 85, and the ceiling 86 are represented by a₁, a₂, as, a₄, a₅, and a₆, respectively, and the areas thereof are represented by S₁, S₂, S₃, S₄, S₅, and S₆, respectively. At this time, assuming that the sound absorption coefficient a₁ of the wall surface 81 is changed, the updated sound absorption coefficient including the average sound absorption coefficient obtained in Step S205 is expressed by the following Formula (5).

$${\overline{a}}^{″} = \frac{{\overline{a}}^{′} {\sum }_{i = 1}^{6} {S}_{i} - {a}_{i} {S}_{i}}{{\sum }_{i = 2}^{6} {S}_{i}} \qquad ( 5 )$$

The sound production apparatus 100 changes the early reflection sound again using the updated sound absorption coefficient indicated by the left side of Formula (5). Then, the sound production apparatus 100 synthesizes the recalculated sound with the updated sound absorption coefficient (Step S209).

After Step S209, the sound production apparatus 100 may further additionally change the sound absorption coefficient of the object (step S210). For example, when the producer 200 confirms the sound generated in Step S209 with audibility, the producer 200 may feel uncomfortable with the sound. For example, the producer 200 may desire to decrease the sound absorption coefficient for an object made of an extremely hard material among objects such as furniture arranged in a space, or to increase the sound absorption coefficient for an object made of a generally soft material such as a sofa. Furthermore, the producer 200 may desire to add a new object to the space.

In a case where the producer 200 inputs a change of the sound absorption coefficient of the additional object (Step S210; Yes), the sound production apparatus 100 changes the sound absorption coefficient of an arbitrary object according to the request of the producer 200. In this case, the sound production apparatus 100 changes the sound absorption coefficient of the object designated by the producer 200 via the user interface (Step S207), and at the same time, changes again the sound absorption coefficient of another boundary or object that has not been changed by the producer 200 so as to maintain the average sound absorption coefficient of the entire space (Step S208). Then, the sound production apparatus 100 recalculates the early reflection sound and the like on the basis of the newly updated sound absorption coefficient, and outputs a synthesized sound.

In a case where there is no input of a change of the sound absorption coefficient of the additional object from the producer 200 (Step S210; No), the sound production apparatus 100 causes the producer 200 to view the sound synthesized in Step S209, and finally confirms whether or not the late reverberation sound is changed (Step S211). In a case where the producer 200 further requests the change of the late reverberation sound (Step S211; Yes), if there is a setting input of the late reverberation sound again from the producer 200, the sound production apparatus 100 changes the late reverberation sound according to the input setting. As described above, in a case where the additional adjustment is necessary, the sound production apparatus 100 repeats the processing from Step S204 to Step S211 until the adjustment becomes unnecessary. Finally, in a case where the producer 200 does not further request the change of the late reverberation sound (Step S211; No), the sound production apparatus 100 ends the process. Note that, in a case where the processing from Step S207 to Step S211 is repeated for the second and subsequent times, for an object whose sound absorption coefficient has been changed by the producer 200 in the previous processing of Step S207, information of the changed object may be stored in the storage device, and for the stored object, the processing of changing the sound absorption coefficient again in Step S208 can be not to be performed. Furthermore, the sound production apparatus 100 may change the sound absorption coefficient of the object changed last time and the sound absorption coefficient of the other object while maintaining the ratio of the sound absorption coefficient of the object changed according to the input of the producer 200 last time and the sound absorption coefficient of the other object.

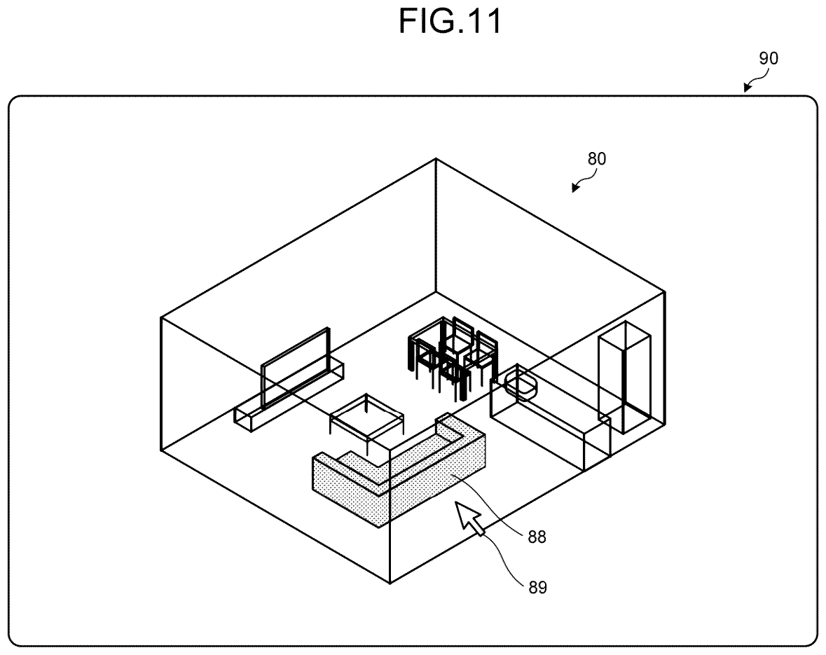

Here, display of the user interface in a case where the producer 200 requests to change the sound absorption coefficient of the object in Step S210 or the like will be described with reference to FIGS. 10 to 12. FIG. 10 is a diagram (1) illustrating a display example of a user interface according to the first embodiment.

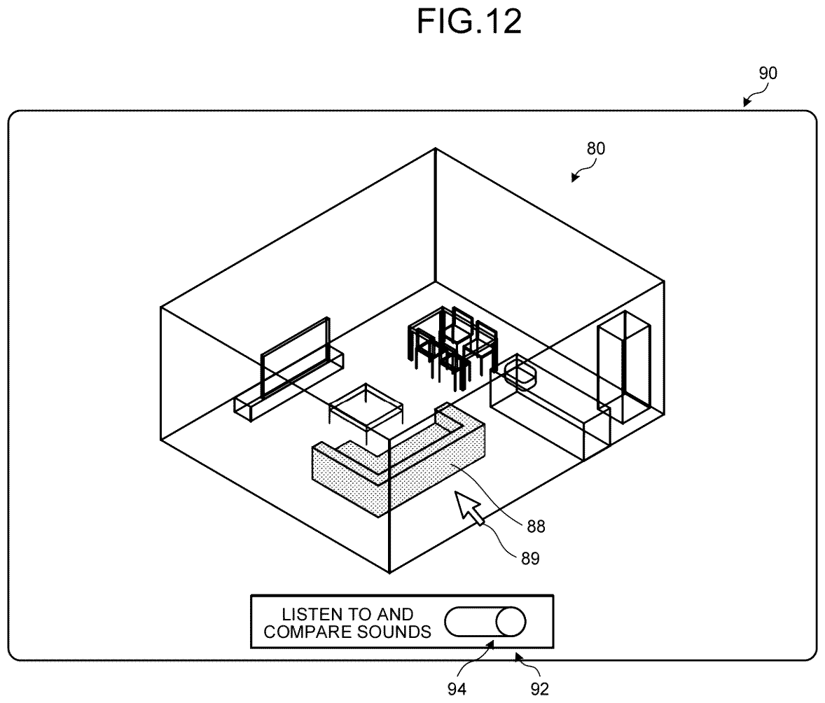

FIG. 10 illustrates a state in which some virtual objects are arranged in the virtual space 80 illustrated in FIG. 9. At the stage after Step S205 in FIG. 7, the boundary and the object of the virtual space 80 are in a state in which a uniform average sound absorption coefficient is set. Here, it is assumed that the producer 200 desires to change the sound absorption coefficient of a sofa 88 which is an example of an object. In this case, the producer 200 executes a desired operation using a user interface as illustrated in FIG. 11.

FIG. 11 is a diagram (2) illustrating a display example of a user interface according to the first embodiment. The sound production apparatus 100 displays a user interface 90 (for example, a window of an application related to sound production) on the display and waits for an input from the producer 200.

For example, the producer 200 operates a cursor 89 indicating an input position using an input device (a pointing device such as a keyboard and a mouse, a microphone (sound), a camera (line of sight and gesture), and the like), and selects the sofa 88 which is an object for which a change of sound absorption coefficient is desired. Then, the producer 200 changes the sound absorption coefficient of the sofa 88 by an operation of inputting a desired sound absorption coefficient value or the like.

At this time, the sound production apparatus 100 may improve the visibility by changing the display mode in the user interface 90 for the object changed from the uniform average sound absorption coefficient. For example, the sound production apparatus 100 may change the color of the selected sofa 88 to indicate that the sound absorption coefficient has been changed with respect to surrounding objects. As a result, the sound production apparatus 100 can improve the visibility in production, so that the work environment of the producer 200 can be improved.

Note that the sound production apparatus 100 may request to listen to the sound after the change on the user interface so that the producer 200 can immediately confirm the sound before and after the change when the boundary or the object of the virtual space is changed from the tentative sound absorption coefficient to the average sound absorption coefficient or when the sound absorption coefficient of a specific object is changed as illustrated in FIG. 11. This example will be described with reference to FIG. 12.

FIG. 12 is a diagram (3) illustrating a display example of a user interface according to the first embodiment. As illustrated in FIG. 12, the sound production apparatus 100 displays a window 92 for switching the sound to be output and a switch 94 on the user interface 90.

By operating the switch 94 on the user interface 90, the producer 200 can view, for example, the sound after changing the sound absorption coefficient of a predetermined object and the sound immediately before the change while switching between the sounds. As a result, the sound production apparatus 100 can improve the workability of the producer 200.

### (1-4. Configuration of Sound Production Apparatus According to First Embodiment)

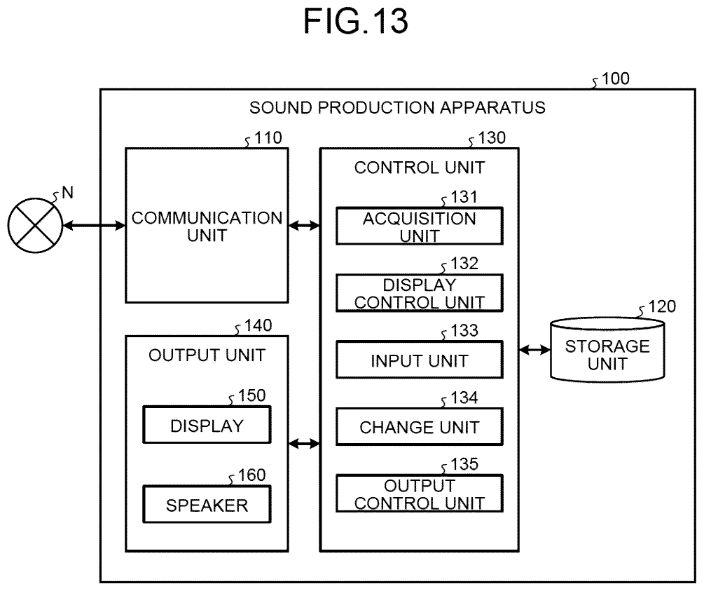

Next, a configuration of the sound production apparatus 100 according to the first embodiment will be described with reference to FIG. 13. FIG. 13 is a diagram illustrating a configuration example of the sound production apparatus 100 according to the first embodiment.

As illustrated in FIG. 13, the sound production apparatus 100 includes a communication unit 110, a storage unit 120, a control unit 130, and an output unit 140. Note that the sound production apparatus 100 may include an input unit (for example, a pointing device such as a touch panel, a keyboard, or a mouse, a voice input microphone, or an image input camera (line-of-sight, gesture input)) or the like that performs various operation inputs from the producer 200 or the like that operates the sound production apparatus 100.

The communication unit 110 is implemented as, for example, a network interface card (NIC) or the like. The communication unit 110 is connected to a network N (Internet, near field communication (NFC), Bluetooth, and the like) in a wired or wireless manner, and transmits and receives information to and from other information devices and the like via the network N.

The storage unit 120 is implemented by, for example, a semiconductor memory element such as a random access memory (RAM) or a flash memory, or a storage device such as a hard disk or an optical disk. The storage unit 120 stores various kinds of data such as sound data output from the sounding point 30, shape data of an object, a preset late reverberation sound setting, and a sound absorption coefficient setting.

The control unit 130 includes, for example, a central processing unit (CPU), micro processing unit (MPU), or the like to cause a program stored in the sound production apparatus 100 (for example, a sound production program according to the present disclosure) to be executed on a random access memory (RAM) or the like as a work area. In addition, the control unit 130 is a controller and may be implemented as, for example, an integrated circuit such as an application-specific integrated circuit (ASIC) or field-programmable gate array (FPGA).

As illustrated in FIG. 13, the control unit 130 includes an acquisition unit 131, a display control unit 132, an input unit 133, a change unit 134, and an output control unit 135, and realizes or executes a function and an action of information processing described below. Moreover, the control unit 130 can have components not limited to the configuration illustrated in FIG. 13, and also can have other configuration as long as it has a component for performing information processing described later.

The acquisition unit 131 acquires various data used for processing by a processing unit in a subsequent stage. For example, the acquisition unit 131 acquires spatial data of a virtual space to be processed. Specifically, the acquisition unit 131 acquires space information indicating the region of the virtual space and coordinate information indicating the configuration of the object.

In addition, the acquisition unit 131 acquires sound data that is a source of a sound output from the sounding point 30 that is a sound source. Furthermore, the acquisition unit 131 may appropriately acquire various types of information required by the processing unit in the subsequent stage, such as a library in which a sound absorption coefficient for each material is stored, and a late reverberation sound preset.

The display control unit 132 displays a virtual space including the sound source object and one or more objects having a first characteristic as the acoustic characteristics. Specifically, the display control unit 132 displays a virtual space including a sound source object such as the sounding point 30, a boundary in which a tentative sound absorption coefficient or the like is set, and a virtual object such as furniture on a user interface visually recognizable by the producer 200. Note that the first characteristic means a tentative sound absorption coefficient or the like that is a parameter temporarily set for calculation of early reflection sound or the like in a stage before the setting of late reverberation sound is input by the producer 200. However, the first characteristic is not limited thereto, and the first characteristic may be a concept including an arbitrary characteristic (parameter) after being changed from the tentative sound absorption coefficient.

Furthermore, in a case where the display target is changed by the processing of the input unit 133 or the change unit 134 in the subsequent stage, the display control unit 132 performs control to change the display on the user interface on the basis of the change.

The input unit 133 inputs setting of characteristics related to late reverberation of the virtual space. For example, the input unit 133 inputs settings of late reverberation sound desired by the producer 200 according to the operation of the producer 200 via the user interface.

Specifically, the input unit 133 inputs, on the user interface, setting of a numerical value of at least one of a late reverberation level, a late reverberation delay time, an attenuation time, a ratio of an attenuation amount for each frequency, an echo density, and a modal density as characteristics related to late reverberation on the basis of data input using an input device (a pointing device such as a touch panel, a keyboard, a mouse, a microphone, a camera, and the like).

Furthermore, the input unit 133 further inputs a change from the average sound absorption coefficient to at least one object existing in the virtual space via the user interface after the characteristics such as the tentative sound absorption coefficient related to at least one object are changed to the average sound absorption coefficient by the change unit 134 in the subsequent stage.

For example, in the virtual space in which the average sound absorption coefficient is uniformly set, the input unit 133 inputs a numerical value for increasing the sound absorption coefficient to furniture such as a sofa that is desired to further increase the sound absorption coefficient, and a floor surface on which a carpet or the like is laid.

At this point, in the case where the change of the characteristic is input to at least one object, the input unit 133 changes the display mode of the object in which the characteristic is changed to the display mode different from the other objects in the user interface.

Specifically, the input unit 133 displays the object whose characteristic has been changed in a color different from other objects. As a result, the producer 200 can visually recognize the object having a changed characteristic such as the sound absorption coefficient at a glance, so that improvement in workability can be expected.

The change unit 134 changes the first characteristic related to at least one object to a second characteristic on the basis of the characteristic related to late reverberation input by the input unit 133. Specifically, the change unit 134 changes the sound absorption coefficient set to the object as the acoustic characteristic related to the object. That is, the first characteristic means, for example, a tentative sound absorption coefficient or the like that is a characteristic initially set for the object. Furthermore, the second characteristic means, for example, an average sound absorption coefficient uniformly set in the entire system of the virtual space after the setting of the late reverberation sound is input. Note that, in this example, the sound absorption coefficient is used as the first characteristic and the second characteristic, but in a case where the sound of the space can be defined on the basis of other parameters, such other parameters may be used.

As described above, first, in a case where the average sound absorption coefficient of the virtual space is calculated from the characteristics related to late reverberation input by the input unit 133, the change unit 134 changes the sound absorption coefficients of all the objects existing in the virtual space to the average sound absorption coefficient. Note that the object in this case includes not only an object such as furniture arranged in the virtual space but also an object constituting a boundary such as a wall surface, a floor surface, or a ceiling.

Thereafter, in a case where the change from the average sound absorption coefficient is input by the input unit 133, the change unit 134 changes the characteristics of the object to which the change of the characteristics is input by the input unit 133 to a third characteristics and changes the characteristics of the other object to a fourth characteristics while maintaining the setting of the characteristics related to the late reverberation of the virtual space. Here, the third characteristic is a parameter such as a sound absorption coefficient designated by the producer 200 for a certain object. As an example, the producer 200 requests, as the third characteristic, a change of a sound absorption coefficient of an object set as a material having a high sound absorption coefficient such as a sofa or a carpet. At this time, in response to a change of the sound absorption coefficient of a certain object while maintaining the late reverberation sound, the change unit 134 also changes the average sound absorption coefficient to another sound absorption coefficient for the other objects. Specifically, the change unit 134 changes the sound absorption coefficient of each object while maintaining the sound absorption coefficient as the system of the entire virtual space by performing the calculation as illustrated in the above Formula (5).

The output control unit 135 outputs in a switchable way a first reproduction sound synthesized based on the characteristic related to late reverberation and the first characteristic and a second reproduction sound synthesized based on the characteristic related to late reverberation and the second characteristic. The first reproduction sound and the second reproduction sound are reproduction sound at a listening point of a sound emitted by the sound source object. For example, the output control unit 135 first outputs a sound (first reproduction sound) synthesized on the basis of the tentative sound absorption coefficient provisionally set and the late reverberation sound setting set by the producer 200. Furthermore, in a case where the tentative sound absorption coefficient is changed to the average sound absorption coefficient on the basis of the late reverberation sound, the output control unit 135 outputs a sound (second reproduction sound) synthesized on the basis of the average sound absorption coefficient and the setting of the late reverberation sound set by the producer 200.

Furthermore, in a case where the sound absorption coefficient or the like of the object is changed on the basis of the operation of the producer 200 via the user interface, the output control unit 135 generates a synthesis sound on the basis of the characteristic after the change, and appropriately outputs the generated sound. That is, in a case where the change of the second characteristic is input by the input unit 133, the output control unit 135 outputs in a switchable way a reproduction sound synthesized before the change of the second characteristic is input by the input unit 133 and a reproduction sound synthesized after the change of the second characteristic is input by the input unit 133. The reproduction sound is at the listening point of the sound emitted by the sound source object.

That is, the output control unit 135 outputs the first reproduction sound and the second reproduction sound by switching therebetween according to the operation of the producer 200 in the user interface. For example, the producer 200 can view the respective synthesized sounds before and after the change of the sound absorption coefficient while switching between the two synthesis sounds via the user interface illustrated in FIG. 12.

Note that, in a case where the change of the second characteristic is input by the input unit 133, the output control unit 135 recalculates the early reflection sound at the listening point in the virtual space including the object having the third characteristic or the fourth characteristic, thereby synthesizing the reproduction sound after the change of the second characteristic is input by the input unit 133. This is because when the sound absorption coefficient of a certain object is changed, even if the acoustic characteristics as the system of the entire virtual space are maintained, the early reflection sound changes depending on the sound absorption coefficient of the individual object arranged in the sound propagation path. The output control unit 135 can appropriately reproduce the changed sound by recalculating the early reflection sound on the basis of the sound absorption coefficient change for each object.

The output unit 140 outputs various types of information. As illustrated in FIG. 13, the output unit 140 includes a display 150 and a speaker 160. Under the control of the display control unit 132, the display 150 displays a virtual space to be processed or displays a user interface for the producer 200 to input an operation. The speaker 160 outputs the synthesized sound or the like under the control of the output control unit 135.

### (1-5. Modification According to First Embodiment)

The information processing according to the first embodiment described above may be accompanied by various modifications. Hereinafter, modifications of the first embodiment will be described.

### (1-5-1. Setting of Sound Absorption Coefficient)

In the process of Step S206 or Step S207 of FIG. 7, the sound production apparatus 100 may give an individual sound absorption coefficient of an object or weight the sound absorption coefficient to be automatically set.

For example, the sound production apparatus 100 performs predetermined weighting on the basis of the information set in the object, and changes the initially set characteristics such as the tentative sound absorption coefficient to the tentative sound absorption coefficient or the like after the late reverberation sound is set by the producer 200. The sound absorption coefficient is obtained, for example, by multiplying the average sound absorption coefficient by a weighting coefficient. For example, the sound production apparatus 100 performs predetermined weighting on the basis of the name or shape of the object as the information set in the object, and changes the first characteristic to the second characteristic.

As an example, the sound production apparatus 100 may perform predetermined weighting on the average sound absorption coefficient obtained in Step S205 on the basis of the setting associated with the name of the boundary or the object, and set the weighted sound absorption coefficient in the boundary or the object. Specifically, in a case where the name of the boundary or the object is a sofa, a cushion, or the like, the sound production apparatus 100 multiplies an average sound absorption coefficient by a predetermined coefficient for increasing the sound absorption coefficient. Alternatively, in a case where the name of the boundary or the object is glass or the like, the sound production apparatus 100 may multiply a predetermined coefficient for reducing the sound absorption coefficient.

Furthermore, the sound production apparatus 100 may perform weighting on the basis of a setting associated with a boundary or a shape of an object. As an example, in a case where the object has a complicated shape such as a sofa, a cushion, a drape curtain, or the like, the sound production apparatus 100 multiplies a predetermined coefficient for increasing the sound absorption coefficient. Alternatively, if the boundary is a flat surface such as a wall surface, the sound production apparatus 100 may multiply a predetermined coefficient for reducing the sound absorption coefficient. Furthermore, the sound production apparatus 100 may perform weighting on the basis of a setting associated with a boundary or a material of an object. As a result, the sound production apparatus 100 can reproduce a more realistic sound space, so that the realistic feeling of the user can be improved, and the workload of the setting processing of the producer 200 can be reduced.

Furthermore, in a case where there is a listening point in the vicinity of a boundary or an object to which an individual sound absorption coefficient is given, the sound production apparatus 100 may give adjustment to a parameter at a predetermined ratio with respect to late reverberation sound.

For example, in a case of assuming a scene where a game character sits on a sofa having a high sound absorption coefficient, the listening point is set in the vicinity of the sofa since the listening point is the head of the game character. In such a case, the sound production apparatus 100 may perform predetermined weighting so that the sound viewed by the user becomes a sound strongly influenced by the sofa. As a result, the sound production apparatus 100 can improve the relationship between the early reflection sound and the local late reverberation sound and enhance the realistic feeling.

Furthermore, in a case where there are many acoustically effective boundaries in the vicinity of the listening point without coming into contact with other objects, the sound production apparatus 100 may automatically change parameters such as modal density of late reverberation sound. That is, the sound production apparatus 100 can further enhance the realistic feeling for the user by locally changing the late reverberation sound.

### (1-5-2. Method for Setting Late Reverberation Sound)

In Step S204 of FIG. 7, it has been indicated that the sound production apparatus 100 inputs setting of late reverberation sound from the producer 200. The late reverberation sound is set by, for example, the producer 200 confirming the late reverberation sound audibly or selecting a preset late reverberation sound setting. However, for a content producer who frequently uses music production software or the like, it may be easier to set the late reverberation sound by working while visually recognizing a waveform of the late reverberation sound.

Therefore, the sound production apparatus 100 may display a waveform indicating late reverberation sound on the user interface in the process of executing Steps S204 to S211. Then, the sound production apparatus 100 changes the parameter related to the late reverberation sound by the content producer inputting correction and the like for the waveform. As a result, the sound production apparatus 100 can provide the content producer with an intuitive work environment, so that workability can be further improved. Note that the sound production apparatus 100 may provide an editing environment using waveforms not only for setting late reverberation sound but also for changing other characteristics of objects.

### 2. Second Embodiment

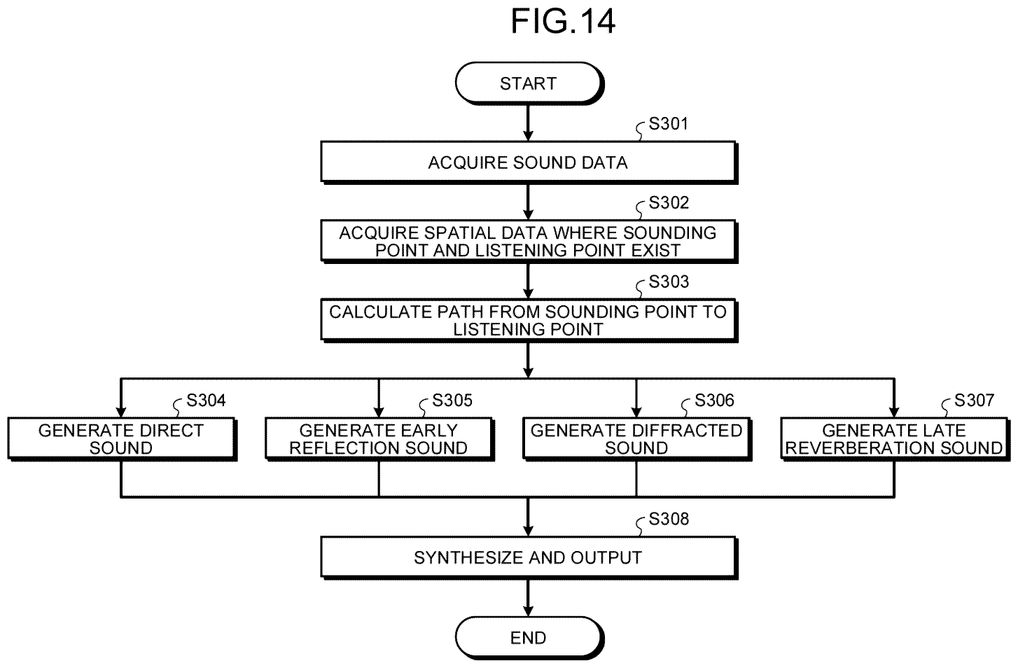

Next, the second embodiment will be described with reference to FIG. 14. FIG. 14 is a flowchart illustrating a process of sound signal generation processing according to the second embodiment. In the second embodiment, sound generation processing is parallelized, for example, in a case where the signal processing arithmetic capability of the sound production apparatus 100 is relatively high.

Steps S301 to S308 illustrated in FIG. 14 correspond to Steps S101 to S108 illustrated in FIG. 4, respectively. As illustrated in FIG. 14, the sound production apparatus 100 according to the second embodiment parallelizes the processing from Step S304 to Step S307. Then, the sound production apparatus 100 synthesizes the respective sounds generated in Steps S304 to S307 and outputs a final reproduction sound (Step S308).

As described above, the sound production apparatus 100 calculates each of the direct sound, the diffracted sound, the early reflection sound, and the late reverberation sound by parallel processing, and synthesizes the reproduction sound on the basis of the calculation result. As a result, the sound production apparatus 100 can reduce the latency (delay) from the start of the sound signal generation processing by parallelizing each process of signal generation. Note that the parallelization is not limited to the example illustrated in FIG. 14, and for example, instead of parallelizing all the generation steps, Steps S304 to S307 may be partially subjected to series processing or partially subjected to parallel processing. At this time, synthesis of the parallelized sounds can be performed at any timing.

### 3. Third Embodiment

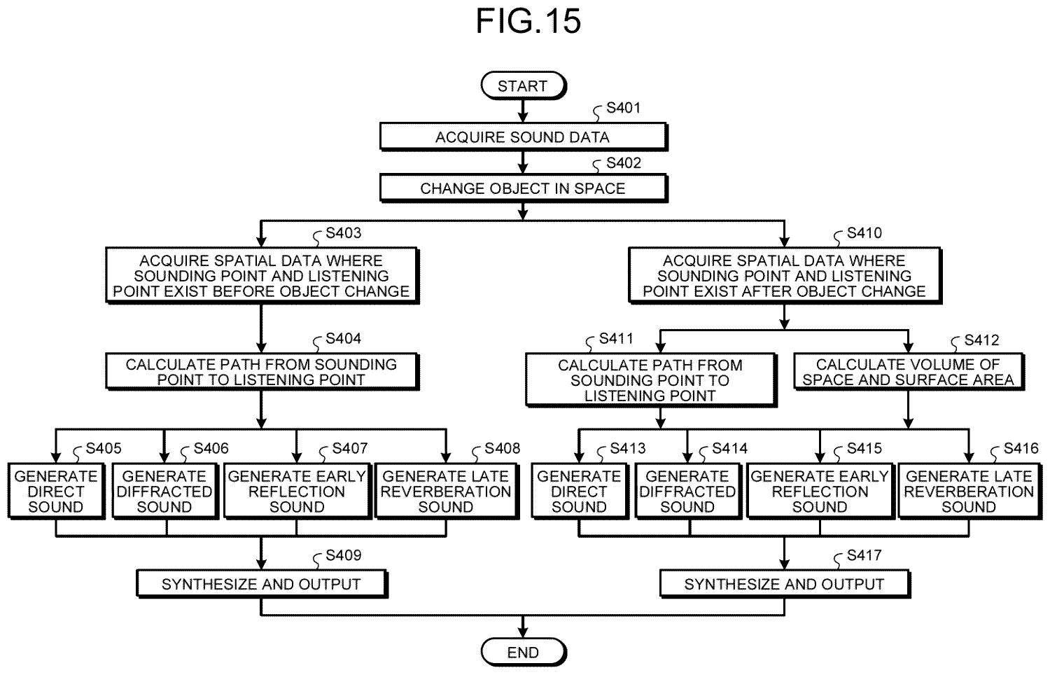

Next, the third embodiment will be described with reference to FIG. 15. FIG. 15 is a flowchart illustrating a process of sound signal generation processing according to the third embodiment. In the third embodiment, when an object in a space is changed, a sound signal before the change and a sound signal after the change are simultaneously calculated.

As illustrated in FIG. 15, the sound production apparatus 100 parallelizes the spatial data acquisition processing before the object change (Step S403) and the processing in the subsequent stage thereof (Steps S404 to S409), and the spatial data acquisition processing after the object change (Step S410) and the processing in the subsequent stage thereof (Steps S411 to S416). Note that each processing is similar to the processing described with reference to FIGS. 2, 7, and the like, and thus description thereof is omitted.

As described above, the sound production apparatus 100 generates the reproduction sound before the change of the sound absorption coefficient is input and the reproduction sound after the change of the sound absorption coefficient is input by parallel processing, and outputs in a switchable way the generated reproduction sound. By parallelizing the sound generation processing before and after the change of the object, the producer 200 can listen to and compare the sounds synthesized before and after the change of the object while immediately switching the sounds. As a result, the sound production apparatus 100 can improve the workability of the producer 200. Note that, in addition to the parallel computation, the sound production apparatus 100 can provide an effect similar to the parallelization, for example, by immediately computing the steps of Step S401, Step S402, and Steps S410 to S417 after the object change operation by the producer 200 and presenting the sound.

### 4. Fourth Embodiment

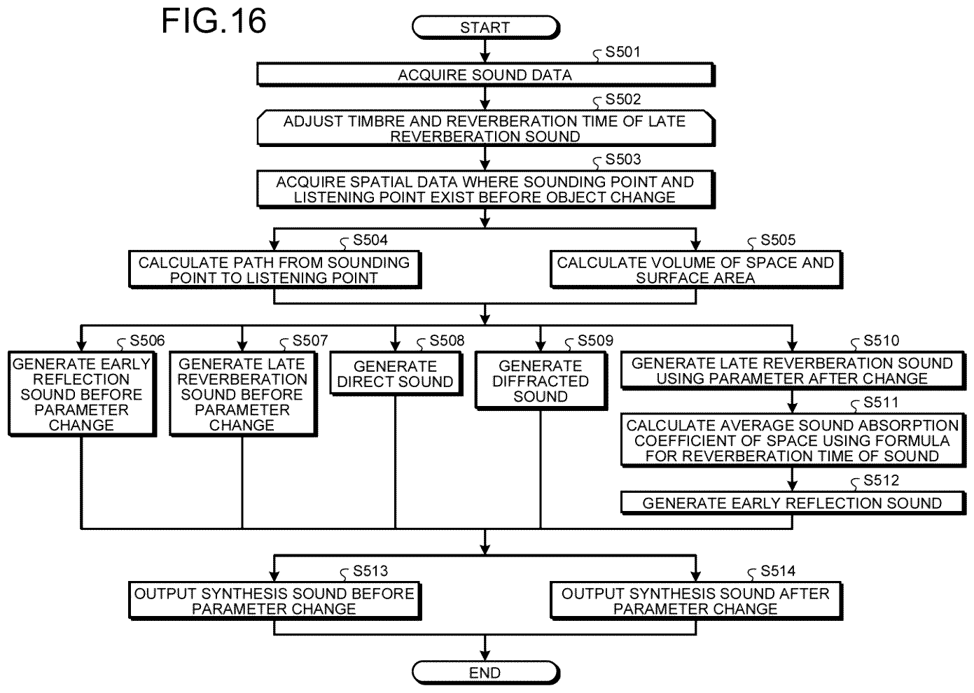

Next, the fourth embodiment will be described with reference to FIG. 16. FIG. 16 is a flowchart illustrating a process of sound signal generation processing according to the fourth embodiment. In the fourth embodiment, similarly to the third embodiment, in a case where the producer 200 changes various parameters, the sound before and after the change can be immediately switched.

As illustrated in FIG. 16, in the fourth embodiment, the processing of generating the direct sound and the diffracted sound that are not affected by the parameter change (Steps S508 and S509) is input for any synthesis processing (Steps S513 and S514) before and after the parameter change. Note that the sound production apparatus 100 may synthesize the output of the direct sound and the diffracted sound in advance before the synthesis processing (Steps S513 and S514).

As described above, the sound production apparatus 100 uses the direct sound and the diffracted sound calculated before the change of the sound absorption coefficient is input for synthesis of the reproduction sound after the change of the sound absorption coefficient is input, and synthesizes the reproduction sound after the change of the sound absorption coefficient is input. That is, the sound production apparatus 100 uses the values calculated in the processes that are not affected before and after the parameter change for the synthesis processing before and after the parameter change, so that it is not necessary to perform all the processing processes before and after the parameter change, and the processing speed can be improved.

### 5. Fifth Embodiment

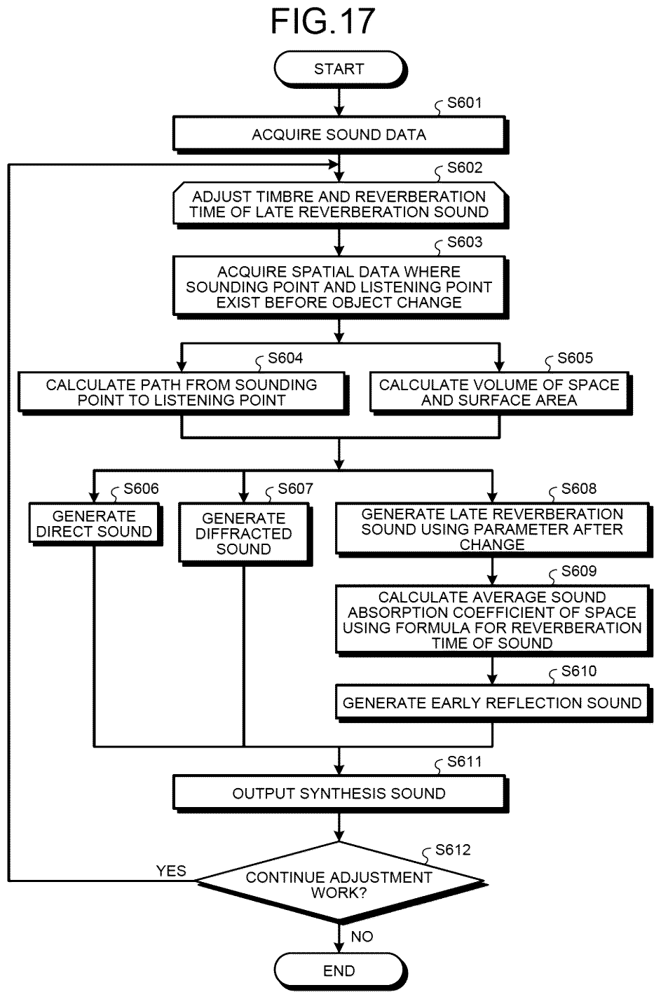

Next, the fifth embodiment will be described with reference to FIG. 17. FIG. 17 is a flowchart illustrating a process of sound signal generation processing according to the fifth embodiment. In the fifth embodiment, in a case where the producer 200 changes various parameters, sounds after the change are sequentially calculated.

As illustrated in FIG. 17, in the fifth embodiment, when the producer 200 updates the parameter of the late reverberation sound, the synthesized output after the change is sequentially calculated. Specifically, after the synthesis sound is output (Step S611), the sound production apparatus 100 determines whether or not the adjustment work by the producer 200 is continued (Step S612). If the producer 200 desires to continue the adjustment work (Step S612; Yes), the sound production apparatus 100 immediately calculates the synthesis sound after the change by using the parameter after the change such as a newly input parameter (Steps S603 to S611). On the other hand, if the producer 200 does not desire to continue the adjustment work (Step S612; No), the sound production apparatus 100 ends the process.

As a result, the sound production apparatus 100 can output the synthesis sound after the change without delay in accordance with the operation of the producer 200.

### 6. Sixth Embodiment

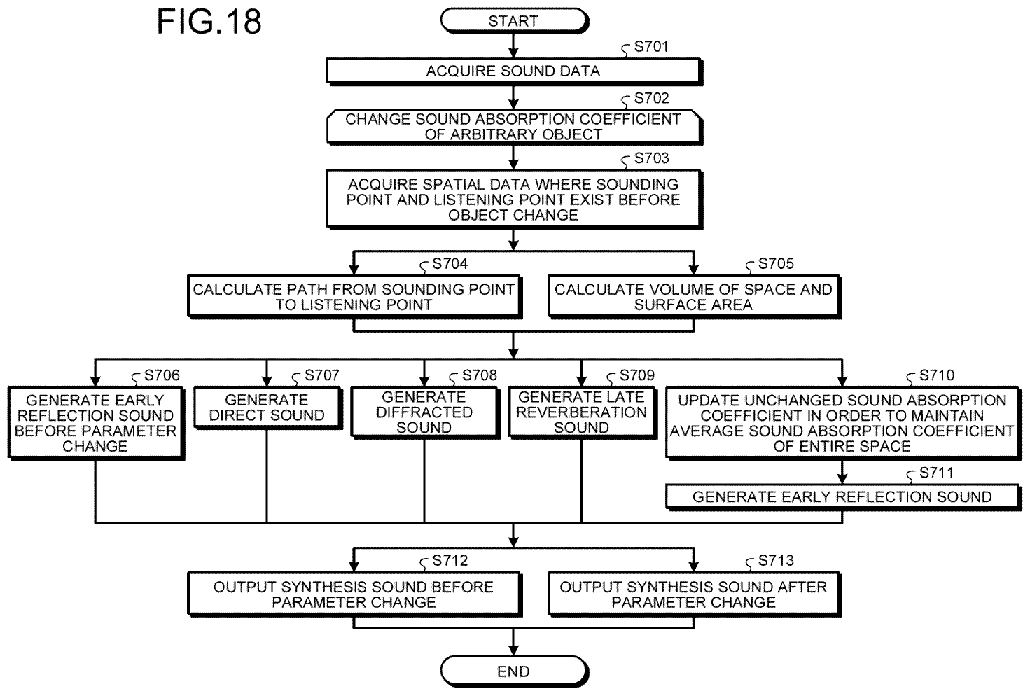

Next, the sixth embodiment will be described with reference to FIG. 18. FIG. 18 is a flowchart illustrating a process of sound signal generation processing according to the sixth embodiment. In the sixth embodiment, in a case where the producer 200 changes various parameters, sounds after the change are sequentially calculated.

As illustrated in FIG. 18, in the sixth embodiment, when the producer 200 sets or changes the parameter of the late reverberation sound, generation of the early reflection sound before the parameter change (Step S706) and generation of the early reflection sound based on the sound absorption coefficient after the parameter change (Step S710) are parallelized.

Also by such processing, since the sound production apparatus 100 can generate the sounds before and after the parameter change in parallel, it is possible to immediately respond to the sound switching request by the producer 200.

### 7. Other Embodiments

The processing according to the above-described embodiment may be implemented in various different modes other than the above-described embodiment.

In addition, among the processing described in the above embodiments, all or a part of the processing, described as automatic processing, can be performed manually, or all or a part of the processing, described as manual processing, can be performed automatically by a known method. In addition, the processing procedures, specific names, and information including various data and parameters indicated in the above document and the drawings can be arbitrarily changed unless otherwise specified. For example, various types of information illustrated in the drawings are not limited to the illustrated information.

Furthermore, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in any units according to various loads, usage conditions, and the like.

Furthermore, the above-described embodiments and modifications can be appropriately combined within a range that the processing contents do not contradict each other.

In addition, the effects described in the present specification are merely examples and are not limited, and other effects may be provided.

### 8. Effects of Sound Production Apparatus According to Present Disclosure

As described above, the sound production apparatus (the sound production apparatus 100 in the embodiment) according to the present disclosure includes an acquisition unit (the acquisition unit 131 in the embodiment), a display control unit (the display control unit 132 in the embodiment), an input unit (the input unit 133 in the embodiment), a change unit (the change unit 134 in the embodiment), and an output control unit (the output control unit 135 in the embodiment). The acquisition unit acquires space information indicating a region of the three-dimensional virtual space including the sound source object and one or more three-dimensional objects having the first characteristic (a characteristic before being changed to a certain value, for example, a provisionally set tentative sound absorption coefficient) as an acoustic characteristic, and coordinate information (spatial data in the embodiment) indicating the configuration of the three-dimensional objects. The display control unit displays the three-dimensional virtual space. The input unit inputs setting of characteristics related to late reverberation of the three-dimensional virtual space. The change unit changes the first characteristic related to at least one three-dimensional object to the second characteristic (characteristic value after the change, for example, the average sound absorption coefficient obtained based on late reverberation sound) on the basis of the characteristics related to late reverberation input by the input unit. The output control unit outputs in a switchable way the first reproduction sound synthesized based on the characteristic related to late reverberation and the first characteristic and the second reproduction sound synthesized based on the characteristic related to late reverberation and the second characteristic. The first reproduction sound and the second reproduction sound are reproduction sound at a listening point of a sound emitted by the sound source object.

As described above, the sound production apparatus changes the characteristics of the boundary, furniture, and the like existing in the space by inputting the setting values of the characteristics related to the late reverberation of the three-dimensional virtual space. Furthermore, the sound production apparatus outputs the sound before and after the change. As a result, the sound production apparatus can reproduce a realistic sound space in which the early reflection sound and the late reverberation sound are matched without taking time and effort for the producer to set the characteristics of the space one by one.

Furthermore, the input unit inputs at least one of settings of a late reverberation level, a delay time of late reverberation, an attenuation time, a ratio of an attenuation amount for each frequency, an echo density, and a modal density as a characteristic related to late reverberation.

As described above, the sound production apparatus can realize the late reverberation sound desired by the producer with high accuracy by inputting various parameters related to the late reverberation sound.

Furthermore, the change unit changes the sound absorption coefficient set to the three-dimensional object as the acoustic characteristic related to the three-dimensional object.

As described above, the sound production apparatus can set the characteristics of the virtual space that do not contradict the late reverberation sound set by the producer by changing the sound absorption coefficient of the object or the boundary.

In addition, if the average sound absorption coefficient of the three-dimensional virtual space is calculated from the characteristics related to late reverberation input by the input unit, the change unit changes the sound absorption coefficients of all the three-dimensional objects existing in the three-dimensional virtual space to the average sound absorption coefficient.

As described above, the sound production apparatus sets the average sound absorption coefficient uniformly for the objects arranged in the entire three-dimensional virtual space as one system. As a result, the sound production apparatus can set a space that does not contradict the late reverberation sound.

In addition, after the first characteristic related to the at least one three-dimensional object is changed to the second characteristic by the change unit, the input unit further inputs the change of the second characteristic to the at least one three-dimensional object existing in the three-dimensional virtual space via the user interface. In a case where the change of the second characteristic is input by the input unit, the change unit changes the characteristic of the three-dimensional object to which the change of the second characteristic is input by the input unit to the third characteristic and changes a characteristic of the other three-dimensional object to the fourth characteristic while maintaining the setting of the characteristics related to the late reverberation of the three-dimensional virtual space.

As described above, the sound production apparatus individually inputs the change of the characteristics of the object and the boundary after the average sound absorption coefficient and the like are set. At this time, the sound production apparatus changes the characteristics of the individual objects while maintaining the sound absorption coefficient as the system of the entire virtual space. As a result, the sound production apparatus can synthesize the reproduction sound that does not contradict the late reverberation sound as a whole while meeting the needs of the producer such as changing the sound absorption coefficient of a specific object.

Furthermore, in the case where the change of the second characteristic is input to at least one three-dimensional object, the input unit changes the display mode of the three-dimensional object in which the second characteristic is changed to the display mode different from the other three-dimensional objects in the user interface.

For example, the input unit displays the three-dimensional object whose second characteristic has been changed in a color different from other three-dimensional objects.

As described above, the sound production apparatus can provide the producer with a production environment with high visibility by changing the display mode on the user interface.

In addition, in a case where the change of the second characteristic is input by the input unit, the output control unit outputs in a switchable way a reproduction sound synthesized before the change of the second characteristic is input by the input unit and a reproduction sound synthesized after the change of the second characteristic is input by the input unit. The reproduction sound is at the listening point of the sound emitted by the sound source object.

As described above, even in a case where a characteristic of an individual object is changed, the sound production apparatus can output sounds before and after the change in a switchable manner. As a result, the sound production apparatus can improve the workability of the producer who works while frequently listening to and comparing the sounds before and after the change.

In addition, in a case where the change of the second characteristic is input by the input unit, the output control unit recalculates the early reflection sound at the listening point in the three-dimensional virtual space including the three-dimensional object having the third characteristic or the fourth characteristic, thereby synthesizing the reproduction sound after the change of the second characteristic is input by the input unit.

As described above, in a case where the sound absorption coefficient is changed, the sound production apparatus recalculates the early reflection sound, so that it is possible to output the synthesis sound reflecting the change while maintaining the sound absorption coefficient as the entire system.

In addition, the output control unit outputs the first reproduction sound and the second reproduction sound by switching therebetween according to the operation of an operator (the producer 200 in the embodiment) in the user interface.

As described above, the sound production apparatus can enhance the workability of the operator by providing the operator with an interface such as a changeover switch.

Furthermore, the sound production apparatus may be an apparatus that executes a sound production method including the following steps. The sound production method includes an acquisition step, an input step, a change step, and an output control step. The acquisition step acquires space information indicating a region of the three-dimensional virtual space and coordinate information indicating a configuration of one or more three-dimensional objects existing in the three-dimensional virtual space and having the first characteristic as the acoustic characteristic. The input step inputs setting of characteristics related to late reverberation of the three-dimensional virtual space. The change step changes the first characteristic related to at least one three-dimensional object to the second characteristic on the basis of the characteristic related to the input late reverberation. The output control step outputs a reproduction sound at a listening point of the sound emitted by the sound source object arranged in the three-dimensional virtual space. The reproduction sound is synthesized on the basis of the characteristic related to late reverberation and the second characteristic.

In addition, the output control step calculates, by parallel processing, each of a direct sound from the sound source object to a listening point, a diffracted sound from the sound source object to a listening point, an early reflection sound calculated based on the second characteristic, and a late reverberation sound calculated based on the characteristic related to the late reverberation, and synthesizes the reproduction sound based on a calculation result.

As described above, according to the sound production method, the delay until the sound synthesis processing can be reduced by parallelizing the sound generation processing.

In addition, the output control step generates a reproduction sound before the change of the second characteristic is input by the input step and a reproduction sound after the change of the second characteristic is input by the input step by parallel processing, and outputs in a switchable way the generated reproduction sound.

As described above, according to the sound production method, by parallelizing the synthesis processing of the sounds before and after the parameter change, it is possible to immediately respond to the request for switching the sound by the producer.

Further, the output control step synthesizes a reproduction sound after the change of the second characteristic is input by the input step by using a direct sound and a diffracted sound calculated before the change of the second characteristic is input by the input step for synthesis of the reproduction sound after the change of the second characteristic is input by the input step.

As described above, according to the sound production method, the synthesis processing can be speeded up by using the sound that does not change before and after the parameter change for the synthesis processing after the parameter change.

Furthermore, the change step performs predetermined weighting based on information set in the three-dimensional object and changes the first characteristic to the second characteristic.

For example, the change step performs predetermined weighting base on a name or shape of the three-dimensional object as information set in the three-dimensional object, and changes the first characteristic to the second characteristic.

As described above, according to the sound production method, by performing weighting on the basis of information or the like set in advance for the object, it is possible to set the sound absorption coefficient according to each object instead of setting all the objects to a uniform average sound absorption coefficient or the like.

### 9. Hardware Configuration

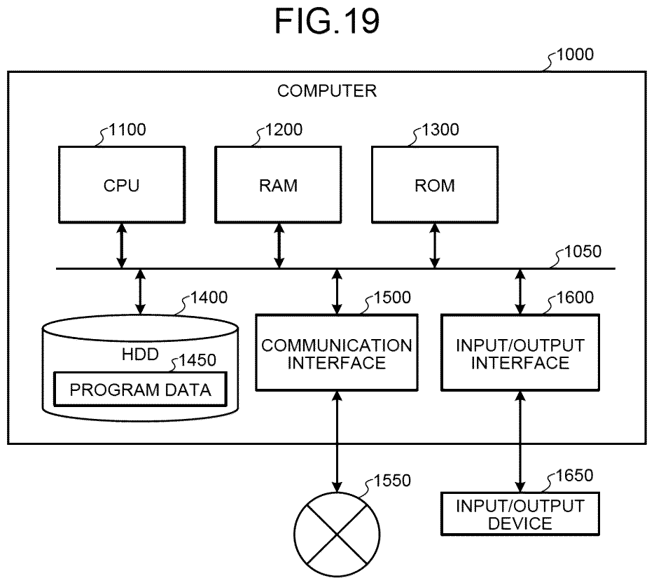

The information device such as the sound production apparatus 100 according to the above-described embodiments is implemented by a computer 1000 having a configuration as illustrated in FIG. 19, for example. Hereinafter, the sound production apparatus 100 according to the first embodiment will be described as an example. FIG. 19 is a hardware configuration diagram illustrating an example of the computer 1000 that implements functions of the sound production apparatus 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 decompresses a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is started, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records a sound production program according to the present disclosure, which is an example of a program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting a input/output device 1650 and the computer 1000. For example, the CPU 1100 receives data from an input device such as a touch panel, a keyboard, a mouse, a microphone, or a camera via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the sound production apparatus 100 according to the first embodiment, the CPU 1100 of the computer 1000 implements the functions of the control unit 130 and the like by executing the sound production program loaded on the RAM 1200. In addition, the HDD 1400 stores the sound production program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also have the following configurations.

(1) A sound production apparatus comprising:
an acquisition unit configured to acquire space information indicating a region of a three-dimensional virtual space including a sound source object and one or more three-dimensional objects having a first characteristic as an acoustic characteristic, and coordinate information indicating a configuration of the three-dimensional object;
a display control unit configured to display the three-dimensional virtual space;
an input unit configured to input setting of a characteristic related to late reverberation of the three-dimensional virtual space;
a change unit configured to change the first characteristic related to at least one of the three-dimensional objects to a second characteristic based on the characteristic related to late reverberation input by the input unit; and
an output control unit configured to output in a switchable way a first reproduction sound synthesized based on the characteristic related to late reverberation and the first characteristic and a second reproduction sound synthesized based on the characteristic related to late reverberation and the second characteristic, the first reproduction sound and the second reproduction sound being a reproduction sound at a listening point of a sound emitted by the sound source object.
   (2) The sound production apparatus according to (1), wherein
the input unit
inputs at least one of settings of a late reverberation level, a delay time of late reverberation, an attenuation time, a ratio of an attenuation amount for each frequency, an echo density, and a modal density as the characteristic related to late reverberation.
   (3) The sound production apparatus according to (1) or (2), wherein
the change unit
changes a sound absorption coefficient set to the three-dimensional object as the acoustic characteristic related to the three-dimensional object.
   (4) The sound production apparatus according to (3), wherein
the change unit,
in a case where an average sound absorption coefficient of the three-dimensional virtual space is calculated from a characteristic related to late reverberation input by the input unit, changes sound absorption coefficients of all the three-dimensional objects existing in the three-dimensional virtual space to the average sound absorption coefficient.
   (5) The sound production apparatus according to any one of (1) to (4), wherein
the input unit,
after the first characteristic related to at least one of the three-dimensional objects is changed to the second characteristic by the change unit, further inputs a change of the second characteristic to at least one of the three-dimensional objects existing in the three-dimensional virtual space via a user interface, and
the change unit,
in a case where the change of the second characteristic is input by the input unit, changes a characteristic of the three-dimensional object to which the change of the second characteristic is input by the input unit to a third characteristic and changes a characteristic of another three-dimensional object to a fourth characteristic while maintaining setting of a characteristic related to late reverberation of the three-dimensional virtual space.
   (6) The sound production apparatus according to (5), wherein
the input unit,
in a case where the change of the second characteristic is input to at least one of the three-dimensional objects, changes a display mode of the three-dimensional object whose the second characteristic is changed to a display mode different from the other three-dimensional objects in the user interface.
   (7) The sound production apparatus according to (6), wherein,
the input unit
displays the three-dimensional object whose the second characteristic is changed in a color different from the other three-dimensional objects.
   (8) The sound production apparatus according to any one of (5) to (7), wherein
the output control unit,
in a case where the change of the second characteristic is input by the input unit, outputs in a switchable way a reproduction sound synthesized before the change of the second characteristic is input by the input unit and a reproduction sound synthesized after the change of the second characteristic is input by the input unit, the reproduction sound being at the listening point of the sound emitted by the sound source object.
   (9) The sound production apparatus according to (8), wherein
the output control unit,
in a case where the change of the second characteristic is input by the input unit, recalculates an early reflection sound at the listening point in the three-dimensional virtual space including the three-dimensional object having the third characteristic or the fourth characteristic, to synthesize a reproduction sound after the change of the second characteristic is input by the input unit.
   (10) The sound production apparatus according to any one of (1) to (9), wherein
the output control unit
outputs the first reproduction sound and the second reproduction sound by switching therebetween according to an operation of an operator in a user interface.
   (11) A sound production method executed by a computer, comprising:
an acquisition step of acquiring space information indicating a region of a three-dimensional virtual space and coordinate information indicating a configuration of one or more three-dimensional objects existing in the three-dimensional virtual space and having a first characteristic as an acoustic characteristic;
an input step of inputting setting of a characteristic related to late reverberation of the three-dimensional virtual space;
a change step of changing a first characteristic related to at least one of the three-dimensional objects to a second characteristic based on the inputted characteristic related to late reverberation; and
an output control step of outputting a reproduction sound that is a reproduction sound at a listening point of a sound emitted by a sound source object arranged in the three-dimensional virtual space and synthesized based on the characteristic related to late reverberation and the second characteristic.
   (12) The sound production method according to (11), wherein
the output control step
calculates, by parallel processing, each of a direct sound from the sound source object to a listening point, a diffracted sound from the sound source object to a listening point, an early reflection sound calculated based on the second characteristic, and a late reverberation sound calculated based on the characteristic related to late reverberation, and synthesizes the reproduction sound based on a calculation result.
   (13) The sound production method according to (11) or (12), wherein
the input step,
after the first characteristic related to at least one of the three-dimensional objects is changed to the second characteristic by the change step, further inputs a change of the second characteristic to at least one of the three-dimensional objects existing in the three-dimensional virtual space via a user interface, and
the change step,
in a case where the change of the second characteristic is input, changes a characteristic of the three-dimensional object to which the change of the second characteristic is input to a third characteristic and changes a characteristic of another three-dimensional object to a fourth characteristic while maintaining setting of a characteristic related to late reverberation of the three-dimensional virtual space.
   (14) The sound production method according to (13), wherein
the output control step,
in a case where the change of the second characteristic is input by the input step, outputs in a switchable way a reproduction sound synthesized before the change of the second characteristic is input by the input step and a reproduction sound synthesized after the change of the second characteristic is input by the input step, the reproduction sound being at the listening point of the sound emitted by the sound source object.
   (15) The sound production method according to (13) or (14), wherein
the output control step
generates a reproduction sound before the change of the second characteristic is input by the input step and a reproduction sound after the change of the second characteristic is input by the input step by parallel processing, and outputs in a switchable way the generated reproduction sound.
   (16) The sound production method according to (15), wherein
the output control step
synthesizes a reproduction sound after the change of the second characteristic is input by the input step by using a direct sound and a diffracted sound calculated before the change of the second characteristic is input by the input step for synthesis of the reproduction sound after the change of the second characteristic is input by the input step.
   (17) The sound production method according to any one of (11) to (16), wherein
the change step
performs predetermined weighting based on information set in the three-dimensional object and changes the first characteristic to the second characteristic.
   (18) The sound production method according to (17), wherein
the change step
performs predetermined weighting base on a name or shape of the three-dimensional object as information set in the three-dimensional object, and changes the first characteristic to the second characteristic.
   (19) A sound production method comprising:
by a computer,
acquiring space information indicating a region of a three-dimensional virtual space including a sound source object and one or more three-dimensional objects having a first characteristic as an acoustic characteristic, and coordinate information indicating a configuration of the three-dimensional object;
displaying the three-dimensional virtual space;
inputting setting of a characteristic related to late reverberation of the three-dimensional virtual space;
changing the first characteristic related to at least one of the three-dimensional objects to a second characteristic based on the inputted characteristic related to late reverberation; and
outputting in a switchable way a first reproduction sound synthesized based on the characteristic related to late reverberation and the first characteristic and a second reproduction sound synthesized based on the characteristic related to late reverberation and the second characteristic, the first reproduction sound and the second reproduction sound being a reproduction sound at a listening point of a sound emitted by the sound source object.
   (20) A sound production program product, including a sound production program, the sound production program causing
a computer to function as:
an acquisition unit configured to acquire space information indicating a region of a three-dimensional virtual space and coordinate information indicating a configuration of one or more three-dimensional objects existing in the three-dimensional virtual space and having a first characteristic as an acoustic characteristic;
an input unit configured to input setting of a characteristic related to late reverberation of the three-dimensional virtual space;
a change unit configured to change a first characteristic related to at least one of the three-dimensional objects to a second characteristic based on the inputted characteristic related to late reverberation; and
an output control unit configured to output a reproduction sound that is a reproduction sound at a listening point of a sound emitted by a sound source object arranged in the three-dimensional virtual space and synthesized based on the characteristic related to late reverberation and the second characteristic.

### REFERENCE SIGNS LIST

10 VIRTUAL SPACE
100 SOUND PRODUCTION APPARATUS
110 COMMUNICATION UNIT
120 STORAGE UNIT
130 CONTROL UNIT
131 ACQUISITION UNIT
132 DISPLAY CONTROL UNIT
133 INPUT UNIT
134 CHANGE UNIT
135 OUTPUT CONTROL UNIT
200 PRODUCER

1. A sound production apparatus comprising:
an acquisition unit configured to acquire space information indicating a region of a three-dimensional virtual space including a sound source object and one or more three-dimensional objects having a first characteristic as an acoustic characteristic, and coordinate information indicating a configuration of the three-dimensional object;
a display control unit configured to display the three-dimensional virtual space;
an input unit configured to input setting of a characteristic related to late reverberation of the three-dimensional virtual space;
a change unit configured to change the first characteristic related to at least one of the three-dimensional objects to a second characteristic based on the characteristic related to late reverberation input by the input unit; and
an output control unit configured to output in a switchable way a first reproduction sound synthesized based on the characteristic related to late reverberation and the first characteristic and a second reproduction sound synthesized based on the characteristic related to late reverberation and the second characteristic, the first reproduction sound and the second reproduction sound being a reproduction sound at a listening point of a sound emitted by the sound source object.

2. The sound production apparatus according to claim 1, wherein
the input unit
inputs at least one of settings of a late reverberation level, a delay time of late reverberation, an attenuation time, a ratio of an attenuation amount for each frequency, an echo density, and a modal density as the characteristic related to late reverberation.

3. The sound production apparatus according to claim 1, wherein
the change unit
changes a sound absorption coefficient set to the three-dimensional object as the acoustic characteristic related to the three-dimensional object.

4. The sound production apparatus according to claim 3, wherein
the change unit,
in a case where an average sound absorption coefficient of the three-dimensional virtual space is calculated from a characteristic related to late reverberation input by the input unit, changes sound absorption coefficients of all the three-dimensional objects existing in the three-dimensional virtual space to the average sound absorption coefficient.

5. The sound production apparatus according to claim 1, wherein
the input unit,
after the first characteristic related to at least one of the three-dimensional objects is changed to the second characteristic by the change unit, further inputs a change of the second characteristic to at least one of the three-dimensional objects existing in the three-dimensional virtual space via a user interface, and
the change unit,
in a case where the change of the second characteristic is input by the input unit, changes a characteristic of the three-dimensional object to which the change of the second characteristic is input by the input unit to a third characteristic and changes a characteristic of another three-dimensional object to a fourth characteristic while maintaining setting of a characteristic related to late reverberation of the three-dimensional virtual space.

6. The sound production apparatus according to claim 5, wherein
the input unit,
in a case where the change of the second characteristic is input to at least one of the three-dimensional objects, changes a display mode of the three-dimensional object whose the second characteristic is changed to a display mode different from the other three-dimensional objects in the user interface.

7. The sound production apparatus according to claim 6, wherein,
the input unit
displays the three-dimensional object whose the second characteristic is changed in a color different from the other three-dimensional objects.

8. The sound production apparatus according to claim 5, wherein
the output control unit,
in a case where the change of the second characteristic is input by the input unit, outputs in a switchable way a reproduction sound synthesized before the change of the second characteristic is input by the input unit and a reproduction sound synthesized after the change of the second characteristic is input by the input unit, the reproduction sound being at the listening point of the sound emitted by the sound source object.

9. The sound production apparatus according to claim 8, wherein
the output control unit,
in a case where the change of the second characteristic is input by the input unit, recalculates an early reflection sound at the listening point in the three-dimensional virtual space including the three-dimensional object having the third characteristic or the fourth characteristic, to synthesize a reproduction sound after the change of the second characteristic is input by the input unit.

10. The sound production apparatus according to claim 1, wherein
the output control unit
outputs the first reproduction sound and the second reproduction sound by switching therebetween according to an operation of an operator in a user interface.

11. A sound production method executed by a computer, comprising:
an acquisition step of acquiring space information indicating a region of a three-dimensional virtual space and coordinate information indicating a configuration of one or more three-dimensional objects existing in the three-dimensional virtual space and having a first characteristic as an acoustic characteristic;
an input step of inputting setting of a characteristic related to late reverberation of the three-dimensional virtual space;
a change step of changing a first characteristic related to at least one of the three-dimensional objects to a second characteristic based on the inputted characteristic related to late reverberation; and
an output control step of outputting a reproduction sound that is a reproduction sound at a listening point of a sound emitted by a sound source object arranged in the three-dimensional virtual space and synthesized based on the characteristic related to late reverberation and the second characteristic.

12. The sound production method according to claim 11, wherein
the output control step
calculates, by parallel processing, each of a direct sound from the sound source object to a listening point, a diffracted sound from the sound source object to a listening point, an early reflection sound calculated based on the second characteristic, and a late reverberation sound calculated based on the characteristic related to late reverberation, and synthesizes the reproduction sound based on a calculation result.

13. The sound production method according to claim 11, wherein
the input step,
after the first characteristic related to at least one of the three-dimensional objects is changed to the second characteristic by the change step, further inputs a change of the second characteristic to at least one of the three-dimensional objects existing in the three-dimensional virtual space via a user interface, and
the change step,
in a case where the change of the second characteristic is input, changes a characteristic of the three-dimensional object to which the change of the second characteristic is input to a third characteristic and changes a characteristic of another three-dimensional object to a fourth characteristic while maintaining setting of a characteristic related to late reverberation of the three-dimensional virtual space.

14. The sound production method according to claim 13, wherein
the output control step,
in a case where the change of the second characteristic is input by the input step, outputs in a switchable way a reproduction sound synthesized before the change of the second characteristic is input by the input step and a reproduction sound synthesized after the change of the second characteristic is input by the input step, the reproduction sound being at the listening point of the sound emitted by the sound source object.

15. The sound production method according to claim 13, wherein
the output control step
generates a reproduction sound before the change of the second characteristic is input by the input step and a reproduction sound after the change of the second characteristic is input by the input step by parallel processing, and outputs in a switchable way the generated reproduction sound.

16. The sound production method according to claim 15, wherein
the output control step
synthesizes a reproduction sound after the change of the second characteristic is input by the input step by using a direct sound and a diffracted sound calculated before the change of the second characteristic is input by the input step for synthesis of the reproduction sound after the change of the second characteristic is input by the input step.

17. The sound production method according to claim 11, wherein
the change step
performs predetermined weighting based on information set in the three-dimensional object and changes the first characteristic to the second characteristic.

18. The sound production method according to claim 17, wherein
the change step
performs predetermined weighting base on a name or shape of the three-dimensional object as information set in the three-dimensional object, and changes the first characteristic to the second characteristic.

19. A sound production method comprising:
by a computer,
acquiring space information indicating a region of a three-dimensional virtual space including a sound source object and one or more three-dimensional objects having a first characteristic as an acoustic characteristic, and coordinate information indicating a configuration of the three-dimensional object;
displaying the three-dimensional virtual space;
inputting setting of a characteristic related to late reverberation of the three-dimensional virtual space;
changing the first characteristic related to at least one of the three-dimensional objects to a second characteristic based on the inputted characteristic related to late reverberation; and
outputting in a switchable way a first reproduction sound synthesized based on the characteristic related to late reverberation and the first characteristic and a second reproduction sound synthesized based on the characteristic related to late reverberation and the second characteristic, the first reproduction sound and the second reproduction sound being a reproduction sound at a listening point of a sound emitted by the sound source object.

20. A sound production program product, including a sound production program, the sound production program causing
a computer to function as:
an acquisition unit configured to acquire space information indicating a region of a three-dimensional virtual space and coordinate information indicating a configuration of one or more three-dimensional objects existing in the three-dimensional virtual space and having a first characteristic as an acoustic characteristic;
an input unit configured to input setting of a characteristic related to late reverberation of the three-dimensional virtual space;
a change unit configured to change a first characteristic related to at least one of the three-dimensional objects to a second characteristic based on the inputted characteristic related to late reverberation; and
an output control unit configured to output a reproduction sound that is a reproduction sound at a listening point of a sound emitted by a sound source object arranged in the three-dimensional virtual space and synthesized based on the characteristic related to late reverberation and the second characteristic.
